(19) United States
(12) Patent Application Publication
(10) Pub. No.: US 2026/0279047 A1
(43) Pub. Date: Sep. 17, 2026

(54) USING EXTERNAL OBJECT DETECTIONS IN TRANSFORMER-BASED ACTION RECOGNITION

(71) Applicant: Google LLC, Mountain View, CA (US)

(72) Inventors: Xingyi Zhou, Kirkland, WA (US); Cordelia Luise Schmid, Saint-Ismier (FR); Chen Sun, San Francisco, CA (US); Anurag Arnab, Grenoble (FR)

(21) Appl. No.: 19/165,690

(22) PCT Filed: Feb. 1, 2024
(86) PCT No.: PCT/US2024/013945

§ 371 Date: Sep. 16, 2025

Related U.S. Application Data
(60) Provisional application No. 63/456,063, filed on Mar. 31, 2023.

(51) Int. Cl. G06V 20/40; G06N 3/045; G06V 10/82

(52) U.S. Cl. CPC G06V 20/41; G06V 10/82; G06N 3/045

(57) ABSTRACT

The technology provides approaches for use in classifying video data. This includes obtaining input object detections for a video segment having a plurality of video frames (2102). The system identifies, based on the object detections, a set of foreground tokens and a set of background tokens according to object locations in one of the plurality of video frames (2104). Each foreground token and each background token is a nonoverlapping space-time token (2104). The system downsamples the set of background tokens to obtain a reduced set of background tokens (2106). The system applies the set of foreground tokens and the reduced set of background tokens to an object-aware attention module to obtain updated features of patch tokens associated with the frame of the plurality of video frames (2108). The updated features of the patch tokens can then be used to perform a video processing task (2110).

### CROSS-REFERENCE TO RELATED APPLICATIONS

This application claims priority to and the benefit of the filing date of U.S. Provisional Patent Application No. 63/456,063, filed Mar. 31, 2023, the entire disclosure of which is expressly incorporated by reference herein.

### BACKGROUND

Video understanding tasks, such as automated video classification, may involve a machine learning task to determine classifications for video data, e.g., of a video segment or video clip. Various machine learning approaches have been applied to video classification, such as object-based video models and token dropping. Object-based video models can utilize object features to enhance video features. Token dropping may learn a token scoring function in an unsupervised manner without additional information.

Architectures built to model objects may suffer from significant computational overhead. Moreover, videos typically contain a large amount of redundancy, especially when there is little motion or when backgrounds remain static. Processing videos with all the tokens can be both inefficient and distracting. However, depending on how tokens are dropped, this may result in a performance decrease via lower accuracy. These and other issues may adversely impact video classification and related tasks.

### BRIEF SUMMARY

The technology relates to an enhanced approach to video understanding. Aspects of the technology use external object information (e.g., from object detectors) in videos to improve video recognition accuracy, and to reduce redundancy in the input videos. Videos contain a large amount of redundancy, especially when there is little motion or when backgrounds remain static. Object information can be used to gain accuracy, reduce token redundancy, and provide a more compact video representation. Using fewer tokens during processing can also enable stronger test strategies (e.g., multi-crop, longer videos).

As discussed herein, the technology applies an object-based video vision transformer, which may be referred to herein as “ObjectViViT”. This involves an object-guided token sampling strategy (“OGS”) that uses object locations to identify foreground and background tokens. Relevant foreground tokens are retained as-is, while background tokens may be aggressively downsampled before forwarding to a transformer model. In addition, an object-aware attention module (“OAM”) may also be employed. This attention module first creates object tokens by grouping patch tokens from the same object using an object-weighted pooling, and then applies space-time attention on the concatenated object and patch tokens. This way, patch features are augmented with their related object information. Both OGS and OAM are complementary. They can be used individually to improve either token-compactness or accuracy, or can be used together to obtain the benefits of both.

According to one aspect, a computer-implemented method is provided for use in classifying video data. The method comprises: obtaining, by one or more processors, input object detections for a video segment having a plurality of video frames; identifying, by the one or more processors based on the object detections, a set of foreground tokens and a set of background tokens according to object locations in a frame of the plurality of video frames, wherein each foreground token and each background token is a nonoverlapping space-time token; downsampling, by the one or more processors, the set of background tokens to obtain a reduced set of background tokens; applying, by the one or more processors, the set of foreground tokens and the reduced set of background tokens to an object-aware attention module to obtain updated features of patch tokens associated with the frame of the plurality of video frames; and using, by the one or more processors, the updated features of the patch tokens to perform a video processing task.

In one example, the identified foreground tokens are not downsampled. Alternatively or additionally, the method further comprises defining an object score for each foreground token and each background token. In this case, the set of foreground tokens may be identified for any tokens exceeding an object score threshold, and the set of background tokens may be identified for any tokens not exceeding the object score threshold. The object score threshold may be a configurable parameter. Each object score may be based on a set of heatmap values for a corresponding space-time token.

Alternatively or additionally to the above, the object-aware attention module may be configured to obtain the updated features of the patch tokens based on the set of foreground tokens and the reduced set of background tokens, and a corresponding object score for each respective token. Alternatively or additionally to the above, the updated features may include a new object token by weighted pooling of the respective token and the corresponding object score. Alternatively or additionally to the above, the method may further comprise concatenating object tokens and the patch tokens.

Alternatively or additionally to the above, the video processing task may include classifying the video segment. The classification may be based on an action category.

According to another aspect, an image processing system comprises memory configured to store a set of video segments, in which each video segment has a plurality of video frames. The system also comprises one or more processors operatively coupled to the memory, in which the one or more processors are configured to: obtain, from the memory, input object detections for given video segment, and to identify, based on the object detections, a set of foreground tokens and a set of background tokens according to object locations in a frame of the plurality of video frames for the given video segment, wherein each foreground token and each background token is a nonoverlapping space-time token. The one or more processors are further configured to downsample the set of background tokens to obtain a reduced set of background tokens and to apply the set of foreground tokens and the reduced set of background tokens to an object-aware attention module to obtain updated features of patch tokens associated with the frame of the plurality of video frames. Based on this, the one or more processors are configured to use the updated features of the patch tokens to perform a video processing task.

In one example, the identified foreground tokens are not downsampled. The one or more processors may be further configured to define an object score for each foreground token and each background token. Here, the set of foreground tokens may be identified for any tokens exceeding an object score threshold, and the set of background tokens may be identified for any tokens not exceeding the object score threshold. The object score threshold may be a configurable parameter. Each object score may be based on a set of heatmap values for a corresponding space-time token.

Alternatively or additionally to the above, the one or more processors, via the object-aware attention module, may be configured to obtain the updated features of the patch tokens based on the set of foreground tokens and the reduced set of background tokens, and a corresponding object score for each respective token. Alternatively or additionally to the above, the updated features may include a new object token by weighted pooling of the respective token and the corresponding object score.

Alternatively or additionally to the above, the one or more processors may be further configured to concatenate object tokens and the patch tokens. Alternatively or additionally to the above, the video processing task may include classifying the video segment. The classification may be based on an action category.

### BRIEF DESCRIPTION OF THE DRAWINGS

FIG. 1 illustrates an example scenario in accordance with aspects of the technology.

FIG. 2 illustrates a general transformer architecture for use with aspects of the technology.

FIG. 3 depicts a block diagram of an example video understanding model according to example embodiments of the present disclosure.

FIG. 4A depicts a data flow diagram of an example uniform frame sampling approach for tokenizing video data according to example embodiments of the present disclosure.

FIG. 4B depicts a data flow diagram of an example tubelet embedding approach for tokenizing video data according to example aspects of the present disclosure.

FIG. 5A depicts a block diagram of an example factorized encoder according to example embodiments of the present disclosure.

FIG. 5B depicts a block diagram of the factorized encoder discussed with reference to FIG. 5A incorporated into a video understanding model according to example embodiments of the present disclosure.

FIG. 6A depicts a block diagram of an example factorized self-attention mechanism according to example embodiments of the present disclosure.

FIG. 6B depicts a block diagram of an example factorized self-attention mechanism in an example transformer block according to example embodiments of the present disclosure.

FIG. 7 depicts a block diagram of an example factorized dot-product attention mechanism according to example embodiments of the present disclosure.

FIG. 8 depicts a flow chart diagram of an example method for classifying video data with improved accuracy according to example embodiments of the present disclosure.

FIG. 9 depicts a flow chart diagram of an example method for training a video understanding model for classifying video data with improved accuracy according to example embodiments of the present disclosure.

FIG. 10 illustrates an example of an object-based video vision transformer approach in accordance with aspects of the technology.

FIG. 11 illustrates an example of object-guided token sampling in accordance with aspects of the technology.

FIG. 12 illustrates an example of object-aware attention in accordance with aspects of the technology.

FIGS. 13A-C illustrate test results on different benchmarks in accordance with aspects of the technology.

FIGS. 14A-C illustrate additional test results on different benchmarks in accordance with aspects of the technology.

FIGS. 15A-B illustrate qualitative results of object-guided token sampling in accordance with aspects of the technology.

FIG. 16 is a plot of results for background token in object-guided token sampling in accordance with aspects of the technology.

FIGS. 17A-C illustrate tables of ablation studies in accordance with aspects of the technology.

FIG. 18 illustrates a comparison table for object-based video models in accordance with aspects of the technology.

FIG. 19 illustrates a comparison table for token-efficient video transformers in accordance with aspects of the technology.

FIGS. 20A-B illustrate a system for use with aspects of the technology.

FIG. 21 illustrates an example method in accordance with aspects of the technology.

### DETAILED DESCRIPTION

The technology employs a baseline spacetime video vision transformer that can be used for video classification. One of both of object-guided token sampling and an object-aware attention model are employed. For the token sampling, redundant or otherwise less relevant patch tokens are downsampled before the system uses the transformer. The attention model creates object tokens from object-patch relation and uses the object tokens to enhance patch features in the video. Overall, the system takes raw video pixels and object detections (e.g., bounding boxes from an object detector) as input, and is configured to produce an action label (or labels) for the video.

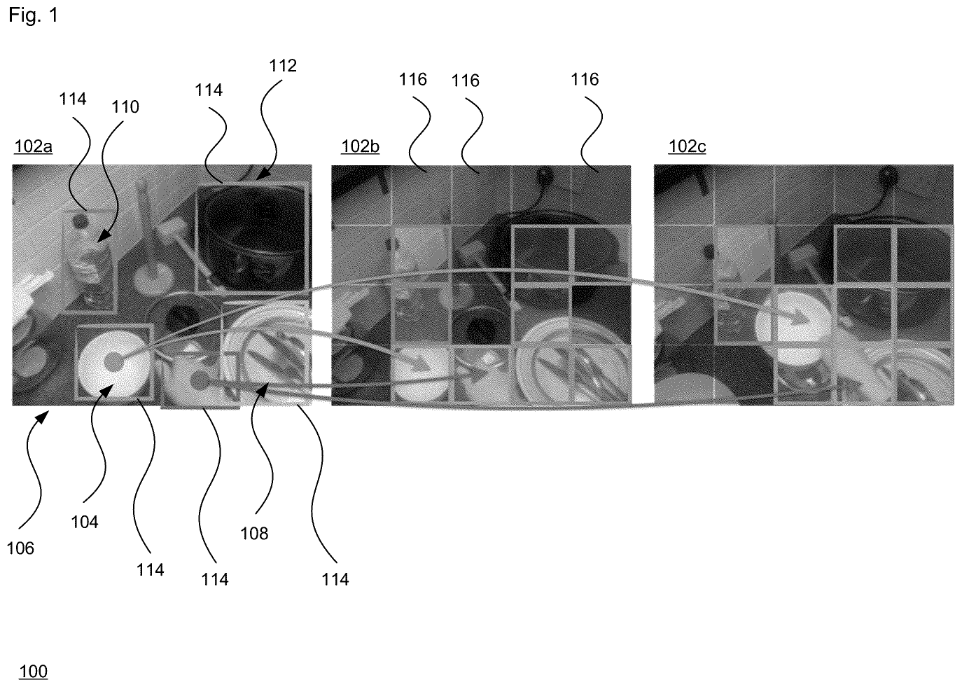

FIG. 1 illustrates an example scenario 100 in which external object information in videos to improve recognition accuracy and to reduce redundancy in the input. This scenario shows three frames 102a, 102b and 102c of a video, and involves an action of picking up a bowl 104 on a countertop packed 106 with kitchenware that also includes a plate with silverware 108. a bottle 110, and a crock pot 112. Objects provide information to: (1) associate image patches (shown as colorful boxes 114) from the same instance, and identify candidates for interactions; (2) selectively build contextual information from redundant background patches (shown as dark boxes 116).

The following begins with a discussion of the general transformer approach, followed by an explanation of a baseline spacetime video vision transformer. Then an explanation is provided for the OGS and OAM techniques that can be used in conjunction with the video vision transformer.

### General Transformer Approach

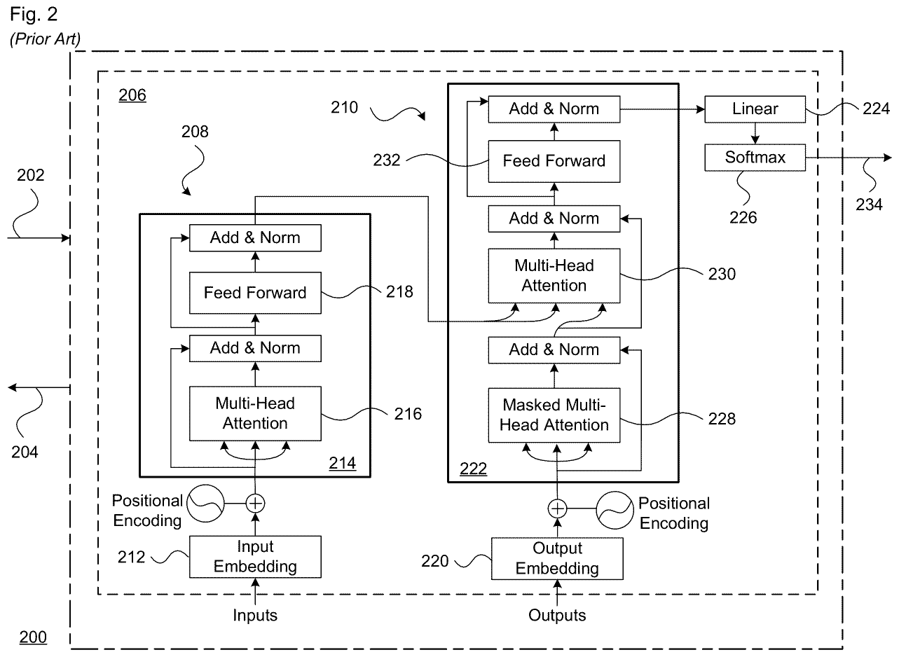

The techniques discussed herein may employ a self-attention architecture, e.g., the Transformer neural network encoder-decoder architecture. An exemplary general Transformer-type architecture is shown in FIG. 2, which is based on the arrangement shown in U.S. Pat. No. 10,452,978, entitled “Attention-based sequence transduction neural networks”, the entire disclosure of which is incorporated herein by reference. See also the article “Attention Is All You Need”, the entire disclosure of which is incorporated herein by reference. While a Transformer-type architecture may be employed, the approach described herein may also be utilized with different architectures. For instance, sequence to sequence models, such as those that use a long short-term memory (LSTM) architecture.

System 200 of FIG. 2 is implementable as computer programs by processors of one or more computers in one or more locations. The system 200 receives an input sequence 202 and processes the input sequence 202 to transduce the input sequence 202 into an output sequence 204. The input sequence 202 has a respective network input at each of multiple input positions in an input order and the output sequence 204 has a respective network output at each of multiple output positions in an output order.

System 200 can perform any of a variety of tasks that require processing sequential inputs to generate sequential outputs. System 200 includes an attention-based sequence transduction neural network 206, which in turn includes an encoder neural network 208 and a decoder neural network 210. The encoder neural network 208 is configured to receive the input sequence 202 and generate a respective encoded representation of each of the network inputs in the input sequence. An encoded representation is a vector or other ordered collection of numeric values. The decoder neural network 210 is then configured to use the encoded representations of the network inputs to generate the output sequence 204. Generally, both the encoder 208 and the decoder 210 are attention-based. In some cases, neither the encoder nor the decoder includes any convolutional layers or any recurrent layers. The encoder neural network 208 includes an embedding layer (input embedding) 212 and a sequence of one or more encoder subnetworks 214. The encoder neural 208 network may N encoder subnetworks 214.

The embedding layer 212 is configured, for each network input in the input sequence, to map the network input to a numeric representation of the network input in an embedding space, e.g., into a vector in the embedding space. The embedding layer 212 then provides the numeric representations of the network inputs to the first subnetwork in the sequence of encoder subnetworks 214. The embedding layer 212 may be configured to map each network input to an embedded representation of the network input and then combine, e.g., sum or average, the embedded representation of the network input with a positional embedding of the input position of the network input in the input order to generate a combined embedded representation of the network input. In some cases, the positional embeddings are learned. As used herein, “learned” means that an operation or a value has been adjusted during the training of the sequence transduction neural network 206. In other cases, the positional embeddings may be fixed and are different for each position.

The combined embedded representation is then used as the numeric representation of the network input. Each of the encoder subnetworks 214 is configured to receive a respective encoder subnetwork input for each of the plurality of input positions and to generate a respective subnetwork output for each of the plurality of input positions. The encoder subnetwork outputs generated by the last encoder subnetwork in the sequence are then used as the encoded representations of the network inputs. For the first encoder subnetwork in the sequence, the encoder subnetwork input is the numeric representations generated by the embedding layer 212, and, for each encoder subnetwork other than the first encoder subnetwork in the sequence, the encoder subnetwork input is the encoder subnetwork output of the preceding encoder subnetwork in the sequence.

Each encoder subnetwork 214 includes an encoder self-attention sub-layer 216. The encoder self-attention sub-layer 216 is configured to receive the subnetwork input for each of the plurality of input positions and, for each particular input position in the input order, apply an attention mechanism over the encoder subnetwork inputs at the input positions using one or more queries derived from the encoder subnetwork input at the particular input position to generate a respective output for the particular input position. In some cases, the attention mechanism is a multi-head attention mechanism as shown. In some implementations, each of the encoder subnetworks 214 may also include a residual connection layer that combines the outputs of the encoder self-attention sub-layer with the inputs to the encoder self-attention sub-layer to generate an encoder self-attention residual output and a layer normalization layer that applies layer normalization to the encoder self-attention residual output. These two layers are collectively referred to as an “Add & Norm” operation in FIG. 2.

Some or all of the encoder subnetworks can also include a position-wise feed-forward layer 218 that is configured to operate on each position in the input sequence separately. In particular, for each input position, the feed-forward layer 218 is configured receive an input at the input position and apply a sequence of transformations to the input at the input position to generate an output for the input position. The inputs received by the position-wise feed-forward layer 218 can be the outputs of the layer normalization layer when the residual and layer normalization layers are included or the outputs of the encoder self-attention sub-layer 216 when the residual and layer normalization layers are not included. The transformations applied by the layer 218 will generally be the same for each input position (but different feed-forward layers in different subnetworks may apply different transformations).

In cases where an encoder subnetwork 214 includes a position-wise feed-forward layer 218 as shown, the encoder subnetwork can also include a residual connection layer that combines the outputs of the position-wise feed-forward layer with the inputs to the position-wise feed-forward layer to generate an encoder position-wise residual output and a layer normalization layer that applies layer normalization to the encoder position-wise residual output. As noted above, these two layers are also collectively referred to as an “Add & Norm” operation. The outputs of this layer normalization layer can then be used as the outputs of the encoder subnetwork 214.

Once the encoder neural network 208 has generated the encoded representations, the decoder neural network 210 is configured to generate the output sequence in an auto-regressive manner. That is, the decoder neural network 210 generates the output sequence, by at each of a plurality of generation time steps, generating a network output for a corresponding output position conditioned on (i) the encoded representations and (ii) network outputs at output positions preceding the output position in the output order. In particular, for a given output position, the decoder neural network generates an output that defines a probability distribution over possible network outputs at the given output position. The decoder neural network can then select a network output for the output position by sampling from the probability distribution or by selecting the network output with the highest probability.

Because the decoder neural network 210 is auto-regressive, at each generation time step, the decoder network 210 operates on the network outputs that have already been generated before the generation time step, i.e., the network outputs at output positions preceding the corresponding output position in the output order. In some implementations, to ensure this is the case during both inference and training, at each generation time step the decoder neural network 210 shifts the already generated network outputs right by one output order position (i.e., introduces a one position offset into the already generated network output sequence) and (as will be described in more detail below) masks certain operations so that positions can only attend to positions up to and including that position in the output sequence (and not subsequent positions). While the remainder of the description below describes that, when generating a given output at a given output position, various components of the decoder 210 operate on data at output positions preceding the given output positions (and not on data at any other output positions), it will be understood that this type of conditioning can be effectively implemented using shifting.

The decoder neural network 210 includes an embedding layer (output embedding) 220, a sequence of decoder subnetworks 222, a linear layer 224, and a softmax layer 226. In particular, the decoder neural network can include N decoder subnetworks 222. However, while the example of FIG. 2 shows the encoder 208 and the decoder 210 including the same number of subnetworks, in some cases the encoder 208 and the decoder 210 include different numbers of subnetworks. The embedding layer 220 is configured to, at each generation time step, for each network output at an output position that precedes the current output position in the output order, map the network output to a numeric representation of the network output in the embedding space. The embedding layer 220 then provides the numeric representations of the network outputs to the first subnetwork 222 in the sequence of decoder subnetworks.

In some implementations, the embedding layer 220 is configured to map each network output to an embedded representation of the network output and combine the embedded representation of the network output with a positional embedding of the output position of the network output in the output order to generate a combined embedded representation of the network output. The combined embedded representation is then used as the numeric representation of the network output. The embedding layer 220 generates the combined embedded representation in the same manner as described above with reference to the embedding layer 212.

Each decoder subnetwork 222 is configured to, at each generation time step, receive a respective decoder subnetwork input for each of the plurality of output positions preceding the corresponding output position and to generate a respective decoder subnetwork output for each of the plurality of output positions preceding the corresponding output position (or equivalently, when the output sequence has been shifted right. each network output at a position up to and including the current output position). In particular, each decoder subnetwork 222 includes two different attention sub-layers: a decoder self-attention sub-layer 228 and an encoder-decoder attention sub-layer 230. Each decoder self-attention sub-layer 228 is configured to, at each generation time step, receive an input for each output position preceding the corresponding output position and, for each of the particular output positions, apply an attention mechanism over the inputs at the output positions preceding the corresponding position using one or more queries derived from the input at the particular output position to generate a updated representation for the particular output position. That is, the decoder self-attention sub-layer 228 applies an attention mechanism that is masked so that it does not attend over or otherwise process any data that is not at a position preceding the current output position in the output sequence.

Each encoder-decoder attention sub-layer 230, on the other hand, is configured to, at each generation time step, receive an input for each output position preceding the corresponding output position and, for each of the output positions, apply an attention mechanism over the encoded representations at the input positions using one or more queries derived from the input for the output position to generate an updated representation for the output position. Thus, the encoder-decoder attention sub-layer 230 applies attention over encoded representations while the decoder self-attention sub-layer 228 applies attention over inputs at output positions.

In the example of FIG. 2, the decoder self-attention sub-layer 228 is shown as being before the encoder-decoder attention sub-layer in the processing order within the decoder subnetwork 222. In other examples, however, the decoder self-attention sub-layer 228 may be after the encoder-decoder attention sub-layer 230 in the processing order within the decoder subnetwork 222 or different subnetworks may have different processing orders. In some implementations, each decoder subnetwork 222 includes, after the decoder self-attention sub-layer 228, after the encoder-decoder attention sub-layer 230, or after each of the two sub-layers, a residual connection layer that combines the outputs of the attention sub-layer with the inputs to the attention sub-layer to generate a residual output and a layer normalization layer that applies layer normalization to the residual output. These two layers being inserted after each of the two sub-layers, both referred to as an “Add & Norm” operation.

Some or all of the decoder subnetwork 222 also include a position-wise feed-forward layer 232 that is configured to operate in a similar manner as the position-wise feed-forward layer 218 from the encoder 208. In particular, the layer 232 is configured to, at each generation time step: for each output position preceding the corresponding output position: receive an input at the output position, and apply a sequence of transformations to the input at the output position to generate an output for the output position. The inputs received by the position-wise feed-forward layer 232 can be the outputs of the layer normalization layer (following the last attention sub-layer in the subnetwork 222) when the residual and layer normalization layers are included or the outputs of the last attention sub-layer in the subnetwork 222 when the residual and layer normalization layers are not included. In cases where a decoder subnetwork 222 includes a position-wise feed-forward layer 232, the decoder subnetwork can also include a residual connection layer that combines the outputs of the position-wise feed-forward layer with the inputs to the position-wise feed-forward layer to generate a decoder position-wise residual output and a layer normalization layer that applies layer normalization to the decoder position-wise residual output. These two layers are also collectively referred to as an “Add & Norm” operation. The outputs of this layer normalization layer can then be used as the outputs of the decoder subnetwork 222.

At each generation time step, the linear layer 224 applies a learned linear transformation to the output of the last decoder subnetwork 222 in order to project the output of the last decoder subnetwork 222 into the appropriate space for processing by the softmax layer 226. The softmax layer 226 then applies a softmax function over the outputs of the linear layer 224 to generate the probability distribution (output probabilities) 234 over the possible network outputs at the generation time step. The decoder 210 can then select a network output from the possible network outputs using the probability distribution.

### Video Vision Transformer

One aspect of the technology employs transformer-based models for video classification. A baseline architecture for a video vision transformer is described below, details of which may be found in U.S. Patent Publication No. 2023/0017072, the entire disclosures of which are incorporated herein by reference.

The video vision transformer models can operate on extracted spatiotemporal tokens from input video, which are then encoded by a series of transformer layers. Model architectures and variations described herein are capable of handling long sequences of tokens encountered in processing video data. For instance, transformer-based models as described herein can be regularized during training. Additionally, according to example aspects of the present disclosure, pretrained image models can be leveraged to provide for training on comparatively smaller video datasets.

In particular, example aspects of the present disclosure provide for transformer-based models for video classification. The transformer-based models can include a self-attention mechanism that computes self-attention on a sequence of spatiotemporal tokens that are extracted from the input video. The models can be factorized along spatiotemporal dimensions to increase efficiency and/or scalability. This can provide for improved usability of the models described herein with video data producing a large number of tokens. Additionally, the models can be regularized during training and/or can utilize pretrained image models to be trained effectively on smaller datasets.

Video understanding models according to example aspects of the present disclosure can adapt a transformer model architecture to process video data. Systems and methods according to example aspects of the present disclosure can be useful for video classifications. For instance, example aspects of the present disclosure can provide for achieving high accuracy on a diverse range of datasets, including different types of video footage, different dataset sizes, etc. with a single family of models. In some implementations, models that have been pre-trained on large image datasets for image classification can be leveraged to bootstrap training of video classification models according to example aspects of the present disclosure.

In some implementations, input to the video understanding model can be or can include video data, such as representations of video data (e.g., tokens). For instance, a computing system can obtain video data. The video data can include a plurality of image frames. The image frames can depict one or more objects. For example, the video data can be a video captured by a mobile device, video camera, or any other suitable video capturing device. The video data can be stored in any suitable manner. For instance, the video data can be stored in computer-readable memory in any suitable format, such as a digital file format (e.g., a .mp4 file format, a .wav file format, etc.). Consider a video V∈V∈ [symbol] ^{T×H×W×C}. For instance, in some implementations, the video data can include a number of image frames (e.g., T), a height (e.g., H), a width (e.g., W), and/or a number of channels (e.g., C). As an example, in some implementations, the video data can include 3 channels, such as a red channel, a green channel, a blue channel, and/or other color channels.

According to example aspects of the present disclosure, a computing system can extract a plurality of video tokens from the video data. The video tokens can be a representation (e.g., an embedding representation) of spatiotemporal information of the video data. In some implementations, the plurality of video tokens is single-dimensional. The video tokens (e.g., the tubelets) may span a single frame t and/or a plurality of frames t. The video tokens (e.g., the tubelets) may be extracted from non-overlapping video data. For instance, a given portion of video data (e.g., a given pixel) may be represented exactly once in the plurality of video tokens (e.g., the tubelets). Additionally and/or alternatively, the video tokens (e.g., the tubelets) may span an entirety of the video data, such as the entire spatiotemporal volume defined by the video data. Processing a video can involve a large number of extracted tokens. Video understanding models according to example aspects of the present disclosure can be designed to process these video tokens, including a large number of video tokens.

For instance, in some implementations, the video tokens can be formed from “tubelets” having a length (e.g., l) and width (e.g., w) and spanning a number of video frames (e.g., t) that are then projected into a tensor representation (e.g., a d-dimensional vector). For instance, in some implementations, extracting the plurality of video tokens can include extracting (e.g., by the computing system) a plurality of video tubelets from the video data. According to example aspects of the present disclosure, N (e.g., non-overlapping) tubelets, xᵢ∈ [symbol] ^{t×h×w} can be extracted from the video data. Intuitively, this approach fuses spatiotemporal information during tokenization, which can be beneficial for improving video understanding.

For instance, the computing system can extract a plurality of tokens \tilde{z}∈ [symbol] ⁿ^{ₜ}^{×n}^{ₕ}^{×n}^{_{w}}^{×d} from tubelets of the video V∈ [symbol] ^{T×H×W×C}, where nₛ among dimension s is the number of tokens along the dimension

$$( e . g . , floor ( \frac{T}{t} ) , floor ( \frac{H}{h} ) , floor ( \frac{W}{w} ) ) .$$

In some implementations, the plurality of video tubelets are nonoverlapping. In some implementations, each of the plurality of video tubelets spans one of the plurality of video frames. In some implementations, each of the plurality of video tubelets spans two or more of the plurality of video frames. Furthermore, in some implementations, a length and/or width of the tubelets may be equivalent to and/or less than a length and/or width of the video data. For instance, in some implementations, a tubelet may be or may include a single (e.g., entire) frame. Smaller tubelets can result in more tokens, which can thus increase computational cost of processing the tokens. However, systems and methods described herein can nonetheless be capable of processing the tokens.

Additionally and/or alternatively, extracting the plurality of video tokens can include projecting, by the computing system, the plurality of video tubelets to a plurality of tensor representations of the plurality of video tubelets. As an example, the plurality of tubelets can be projected by linear projection (e.g., into an array or matrix). For instance, an array of tubelets having size

$$floor ( \frac{T}{t} ) \times floor ( \frac{H}{h} ) \times floor ( \frac{W}{w} ) )$$

can be extracted from the video data.

Additionally and/or alternatively. extracting the plurality of video tokens can include merging (e.g., by the computing system) the plurality of tensor representations along at least one dimension to produce the plurality of video tokens. For instance, the array of tubelets can be compressed into a sequence of d-dimensional token representations by merging spatiotemporal dimensions. As one example, the tokens can be ordered in a single dimension based on frame index and/or position within the frame. This sequence of spatiotemporal tokens can then be passed through the video understanding model.

In some implementations, positional embeddings can be added to the sequence of tokens. As an example, in some implementations, positional embeddings are added to the plurality of video tokens and (e.g., subsequently) input to the video understanding model. For instance, this can assist permutation invariant models (e.g., transformers) with spatiotemporal understanding. As an example, once the positional embeddings are added, in some implementations, the tokens can be reshaped to obtain the input to the video understanding model.

According to example aspects of the present disclosure, a computing system can provide the plurality of video tokens to the video understanding model. The video understanding model can include a video transformer encoder model. The transformer encoder model can include an attention mechanism (e.g., a self-attention mechanism), at least one normalization layer and/or at least one multi-layer perceptron (MLP) layer.

In some implementations, the video understanding model can process the entire sequence of tokens directly. For instance, in some implementations, the video understanding model includes a (e.g., nonfactorized) attention mechanism (e.g., self-attention mechanism), a normalization layer, and a multi-layer perceptron layer. The sequence of tokens (e.g., and/or position embedding(s), classification (CLS) token(s), etc.) can be input directly to this model. The video understanding model can thus model pairwise interactions between all pairs of spatiotemporal tokens in the input sequence. This approach can be computationally expensive, but achieves improved results on large datasets with ample training data. The parameters of this model can be initialized from an image-pretrained model for faster training and higher accuracy.

In some implementations, the video understanding model can include a factorized encoder. The factorized encoder can include two separate subencoders (e.g., transformers) in series. The factorized encoder can include, for instance, a spatial transformer encoder and a temporal transformer encoder. The spatial transformer encoder can be configured to receive the plurality of video tokens and produce, in response to receipt of the plurality of video tokens, a plurality of temporal representations. The temporal transformer encoder can be configured to receive the plurality of temporal representations and produce, in response to receipt of the plurality of temporal representations, a spatiotemporal representation of the video data, wherein the spatiotemporal representation is classified to produce the classification output. For instance, the first subencoder, referred to as the spatial encoder, models interactions between tokens extracted from the same temporal index. A token representation for each temporal index (e.g., frame) is obtained from the first subencoder. For instance, a representation for each temporal index, hᵢ∈ [symbol] ^{d}, can be obtained from the spatial encoder (e.g., after Lₛ layers). If prepended to the input, this can be equivalent to a classification token. Otherwise, this can be a global average pooling from the tokens output by the spatial encoder. The representations across different temporal indices can be aggregated into a single vector. The temporal representations hi can be concatenated into a vector H∈ [symbol] ⁿ^{ᵢ}^{×d}.

Thereafter, a second subencoder, referred to as the temporal encoder, models interactions between these tokens. For instance, the vector can be forwarded through the temporal encoder (e.g., including Lt layers) to model interactions between tokens from different temporal indices. The output from the temporal encoder can then be classified (e.g., by a classification model, such as a multi-layer perceptron model) In some implementations, the parameters of the spatial encoder can be initialized from an image-pretrained model for faster training. This model can be significantly faster than other models (e.g., processing all tokens directly) especially as the sequence length of tokens increases, as it does not compute pairwise interactions between all input tokens. For instance, compared to the model that operates on all tokens directly, the factorized encoder can include a greater number of transformer layers, but require fewer floating point operations (FLOPs) to compute.

Additionally and/or alternatively, in some implementations, the video understanding model can include factorized self-attention. The factorized self-attention mechanism can include a first self-attention block configured to compute spatial self-attention among the plurality of video tokens from a same temporal index and a second self-attention block configured to compute temporal self-attention among the plurality of video tokens from a same spatial index. These computations may be performed sequentially in either order and/or in parallel. Factorized self-attention decomposes the multi-headed self-attention operation within a Transformer layer such that, at first, self-attention is only computed spatially. Thereafter, self-attention is only computed temporally. This can model spatiotemporal interactions more efficiently by factorizing the operation over two smaller sets of elements with comparable computational complexity.

In some implementations, the plurality of video tokens are reshaped prior to being input to the factorized self-attention mechanism. For instance, the tokens can be reshaped from [symbol] ^{1×n}^{ₜ}^{·n}^{ₕ}^{·n}^{_{w}}^{·d} to [symbol] ⁿ^{ₜ}^{×n}^{ₕ}^{·n}^{_{w}}^{·d}. Reshaping the tokens can provide for more efficient computation.

The parameters of the spatial transformer can be initialized from an image-pretrained model. Additionally and/or alternatively, the parameters of the temporal transformer can be initialized as a vector of zeros. This can accelerate training and/or improve overall model performance. The factorized self-attention mechanism can include the same number of transformer layers as the model that operates on all tokens. However, the number of parameters does increase due to the additional self-attention layer. In some implementations, a classification token is not used as part of the input in this model to avoid ambiguities when reshaping the input tokens between spatial and temporal dimensions.

Additionally and/or alternatively, in some implementations, the video understanding model can include factorized dot-product attention. The factorized dot-product attention mechanism can include a plurality of spatial attention heads configured to compute attention weights for each of the plurality of video tokens over a spatial dimension and a plurality of temporal attention heads configured to compute attention weights for each of the plurality of video tokens over a temporal dimension. Factorized dot-product attention factories the multi-head dot-product attention operation within the transformer. As a result, the attention neighborhood for each token is modified to only attend over spatial dimensions and temporal dimensions separately. For instance, the keys and values for each query can be modified to attend over tokens from the same spatial and/or temporal index. A first half of attention heads can attend over tokens from the spatial dimensions and a second half of attention heads can attend over the temporal dimension. In some implementations, outputs from the plurality of spatial attention heads and the plurality of temporal attention heads are combined by concatenation and linear projection.

In some implementations, this model may not add any parameters compared to an image-pretrained model, and thus can be initialized directly from it. The factorized dot-product attention can provide a comparable number of parameters to the model that operates directly on all tokens while having comparable computational complexity to the factorized self-attention and factorized encoder. Note that these embodiments are not mutually exclusive, and a given video understanding model may include none or any other combination of a factorized encoder, factorized self-attention and/or factorized dot-product attention.

According to example aspects of the present disclosure, a computing system can receive a video understanding output from the video understanding model. For instance, in some implementations, the video understanding output can be a video classification output. The video classification output can include data indicative of the video data belonging to at least one class of a plurality of candidate classes. For instance, in some implementations, the video understanding model can output, as the video classification output, a plurality of logit scores respectively associated with the plurality of candidate classes. The logit scores can be indicative of a likelihood, probability, confidence, etc. that the video data belongs to the respective candidate class. For instance, the classification output can include, for each candidate class of the plurality of candidate classes, a logit score respectively associated with the candidate class, where the logit score is indicative of a probability or confidence that the video segment described by the video data is properly classified by the candidate class. In some implementations, the logit scores can be one-hot such that, for a given classification output, a single logit score may be nonzero, with all other logit scores having zero values. In some implementations, the logit scores may be discrete values (e.g., 0 or 1). In some implementations, the logit scores may range from a minimum value (e.g., 0) to a maximum value (e.g., 1).

Additionally and/or alternatively the classification output may be or include a word or phrase descriptive of at least a portion of a video segment described by the video data. For instance, in some implementations, the classification output can be a phrase of one or more words that is descriptive of a subject of the video segment, such as object(s) depicted in the video segment, action(s) performed or described in the video segment, topic(s) included in the video segment, and/or other suitable subjects. As an example, in some implementations, the word or phrase can be output directly from the video classification model. As another example, in some implementations, each candidate class of the plurality of candidate classes (e.g., each logit score) can have a respectively associated word or phrase.

In some implementations, the classification output can be averaged across multiple sets of video data to achieve a final classification output. For instance, in some implementations. longer video segments can be split into multiple views, and each view can be separately input into the video understanding model. The output (e.g., logits) per view can be averaged together to produce a final output for the longer video segments.

One challenge present in the use of video data with machine-learned (e.g., transformer-based) model architectures is that many architectures can require large corpuses of training data to effectively train the model(s). For instance, many architectures operating on image data can be trained using large datasets such as ImageNet 21K, JFT, etc. such that the model(s) can be trained to an acceptable degree. However, generation of video datasets at this scale can be costly, and, as such, comparably-sized datasets generally do not exist for video data. For some machine-learned model architectures, especially those having inductive biases (e.g., convolutional models), this challenge may not be detrimental to use of the model. For some models lacking inductive biases (e.g., transformer models), this can complicate use of the model unless a sufficiently sized dataset is available. For instance, transformer models may only provide effective predictions when trained on large-scale datasets. Currently, even the largest video datasets such as Kinetics have several orders of magnitude fewer labeled examples than corresponding image datasets. As a result, training large models from scratch to high accuracy can be prohibitively challenging. To solve this problem, example aspects of the present disclosure provide for initializing the models described herein from pretrained image models. Example aspects of the present disclosure are directed to effective strategies for leveraging pretrained image models to initialize large-scale video understanding models, such as on how to initialize parameters that may be incompatible with image models.

For instance, in some implementations, a position embedding is added to each input token. However, video models can have many more tokens (e.g., nₜ times more tokens) than image models (e.g., from having t frames). As a result, to initialize the positional embedding, it can be beneficial to repeat the token temporally over each frame. Therefore, at initialization, all tokens with the same spatial index can have the same embedding, which can then be fine-tuned.

As another example, in some implementations, the tubelet embedding filter may be a three-dimensional tensor compared to a two-dimensional tensor in an image model (e.g., due to the temporal dimension). One approach to initialize the three-dimensional filter from the two-dimensional filter is to inflate it by replicating the filter along the temporal dimension and averaging them. Another approach, termed “central frame initialization”, includes initializing the filter with zeroes along all temporal positions except at the temporal center. In this case, the filter can effectively behave like frame sampling at initialization while still having the capability to learn to aggregate temporal information from multiple frames as training progresses.

As another example, in some implementations, the factorized self-attention transformer block can include two multi-headed self-attention (MSA) modules, where a standard image model may include only one MSA module. Thus, in some implementations, the spatial self-attention model can be initialized from the pretrained module and the temporal self-attention model can be initialized with zeroes. In this case, the model behaves as a residual connection at initialization.

Systems and methods according to example aspects of the present disclosure can provide for a number of technical effects and benefits, including improvements to computing technology. For instance, video understanding models including transformers (e.g., attention mechanisms) can outperform some existing models in video understanding tasks such as video classification. For example, models according to example aspects of the present disclosure can achieve improved accuracy of classification outputs on video classification tasks. This can provide for improved user experience, improved data management, etc. As one example, models according to example aspects of the present disclosure can achieve state-of-the-art results on many video classification benchmarks, such as Kinctics (e.g., Kinctics 400 and/or 600), Epic Kitchens 100, Something-Something v2, Moments in Time, etc.

In some implementations, the input to the machine-learned model(s) of the present disclosure can be video data. The machine-learned model(s) can process the video data to generate an output. As an example, the machine-learned model(s) can process the video data to generate a video recognition output (e.g., a recognition of the video data, a latent embedding of the video data, an encoded representation of the video data, a hash of the video data, etc.). As another example, the machine-learned model(s) can process the video data to generate a video segmentation output. As another example, the machine-learned model(s) can process the video data to generate a video classification output. As another example, the machine-learned model(s) can process the video data to generate a video data modification output (e.g., an alteration of the video data, etc.). As another example, the machine-learned model(s) can process the video data to generate an encoded video data output (e.g., an encoded and/or compressed representation of the video data, etc.). As another example, the machine-learned model(s) can process the video data to generate an upscaled video data output. As another example, the machine-learned model(s) can process the video data to generate a prediction output.

Example embodiments of the video vision transformer are discussed in further detail below.

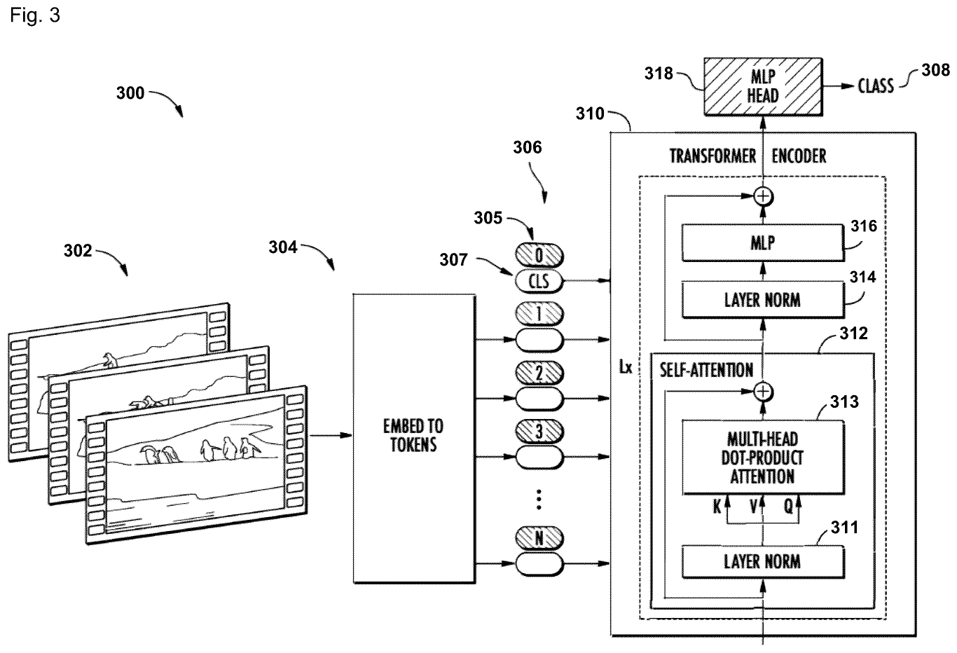

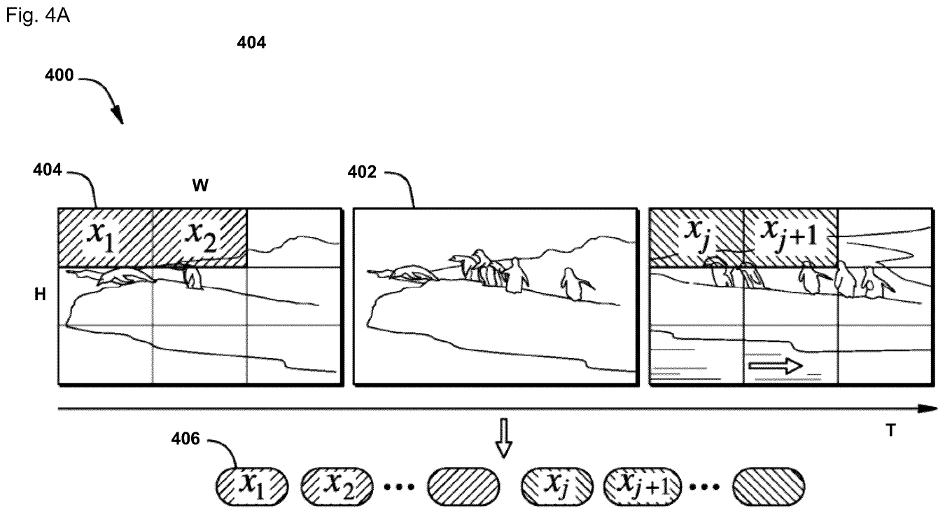

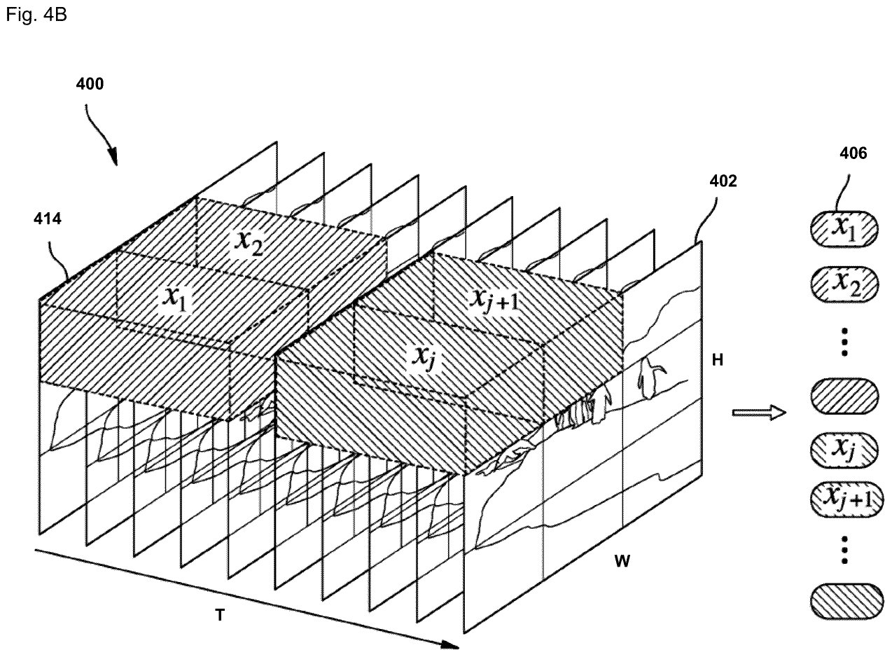

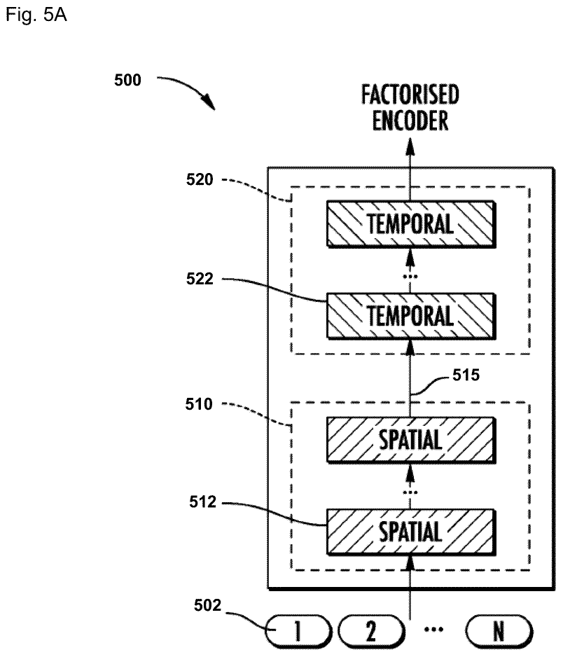

FIG. 3 depicts a block diagram of an example video understanding model 300 according to example embodiments of the present disclosure. The video understanding model 300 can be configured to receive input data 302 (e.g., video data) and produce, in response to receipt of the input data 302, output data 308 (e.g., a classification output). At 304, the model 300 can extract a plurality of video tokens 306 from the video data 302. Example tokenization approaches are discussed with reference to FIGS. 4A through 4B. The video tokens 406 can be a representation (e.g., an embedding representation) of spatiotemporal information of the video data 302. In some implementations, the plurality of video tokens 306 are single-dimensional. Processing a video can involve a large number of extracted tokens. Video understanding model 300 can be designed to process these video tokens, including a large number of video tokens. In some implementations, the tokens 306 can include position embeddings 305. Additionally and/or alternatively, in some implementations, the tokens 306 can include a classification token 307 (e.g., at position 0).

The video understanding model 300 can include a video transformer encoder model 310. The transformer encoder model 310 can include an attention mechanism 312 (e.g., a self-attention mechanism), at least one normalization layer 314 and/or at least one multi-layer perceptron layer 316. The self-attention mechanism 312 can include, for example, a normalization layer 311 that feeds a multi-head dot-product attention mechanism 313. In some implementations, such as in the implementation depicted in FIG. 3, the video understanding model can process the entire sequence of tokens 306 directly. For instance, the sequence of tokens 306 (e.g., and/or position embedding(s) 305, classification (CLS) token(s) 307, etc.) can be input directly to the transformer encoder model 310. The video understanding model 300 can thus model pairwise interactions between all pairs of spatiotemporal tokens in the input sequence. This approach can be computationally expensive, but achieves improved results on large datasets with ample training data. The parameters of this model can be initialized from an image-pretrained model for faster training and higher accuracy. Output from the transformer encoder 310 can be provided to a classification model (e.g., a multi-layer perceptron head) 318 which can classify the output and provide the video classification output 308.

FIG. 4A depicts a data flow diagram of an example uniform frame sampling approach for tokenizing video data according to example embodiments of the present disclosure. For instance, the video data 400 can include a plurality of video frames 402. According to example aspects of the present disclosure, each frame can be broken into one or more “patches” 404. For instance, each patch 404 can span a subset of the length and/or width of a single frame 402. The patches 404 can be single-frame tubelets, for example. Each patch 404 can be projected and/or rasterized into a respective token 406. The tokens 406 can be ordered by frame 402 and/or by patch 404 in a sequence.

FIG. 4B depicts a data flow diagram of an example tubelet embedding approach for tokenizing video data according to example aspects of the present disclosure. As in FIG. 4A, the video data 400 can include a plurality of video frames 402. According to example aspects of the present disclosure, the video data can be decomposed into tubelets 414. Each tubelet can span one or more of the video frames 402. For instance, the tubelets 414 may cover a common spatial region over a plurality of frames. Each tubelet 414 can be projected into a corresponding token 406.

For instance, in some implementations, the video tokens 406 can be formed from tubelets 414 having a length (e.g., 1) and width (e.g., w) and spanning a number of video frames 402 (e.g., t) that are then projected into a tensor representation (e.g., a d-dimensional vector). For instance, in some implementations. extracting the plurality of video tokens 406 can include extracting (e.g., by the computing system) a plurality of video tubelets 414 from the video data 400. According to example aspects of the present disclosure, N (e.g., non-overlapping) tubelets 414, xᵢ∈ [symbol] ^{t×h×w} can be extracted from the video data 400. Intuitively, this approach fuses spatiotemporal information during tokenization, which can be beneficial for improving video understanding.

For instance, the computing system can extract a plurality of tokens 406 (\tilde{z}∈ [symbol] ⁿ^{ₜ}^{×n}^{ₕ}^{×n}^{_{w}}^{×d}) from tubelets 414 of the video 400 (V∈ [symbol] ^{T×H×W×C}), where nₛ among dimension s is the number of tokens 406 along the dimension

$$( e . g . , floor ( \frac{T}{t} ) , floor ( \frac{H}{h} ) , floor ( \frac{W}{w} ) ) .$$

In some implementations, the plurality of video tubelets 3414 are nonoverlapping. In some implementations, each of the plurality of video tubelets 414 spans one of the plurality of video frames 402. In some implementations, each of the plurality of video tubelets 414 spans two or more of the plurality of video frames 402. Furthermore. in some implementations, a length and/or width of the tubelets 414 may be equivalent to and/or less than a length and/or width of the video data 300. For instance, in some implementations, a tubelet 414 may be or may include a single (e.g., entire) frame 402. Smaller tubelets 414 can result in more tokens 406, which can thus increase computational cost of processing the tokens 406. However, systems and methods described herein can nonetheless be capable of processing the tokens 406.

Additionally and/or alternatively. extracting the plurality of video tokens 406 can include projecting, by the computing system, the plurality of video tubelets 414 to a plurality of tensor representations of the plurality of video tubelets 414. As an example, the plurality of tubelets 414 can be projected by linear projection (e.g., into an array or matrix). For instance, an array of tubelets 414 having size

$$floor ( \frac{T}{t} ) \times floor ( \frac{H}{h} ) \times floor ( \frac{W}{w} ) )$$

can be extracted from the video data 400.

Additionally and/or alternatively, extracting the plurality of video tokens 406 can include merging (e.g., by the computing system) the plurality of tensor representations along at least one dimension to produce the plurality of video tokens 406. For instance, the array of tubelets 414 can be compressed into a sequence of d-dimensional token 406 representations by merging spatiotemporal dimensions. As one example, the tokens 406 can be ordered in a single dimension based on frame 402 index and/or position within the frame 402. This sequence of spatiotemporal tokens 406 can then be passed through the video understanding model (e.g., video understanding model 200 of FIG. 3).

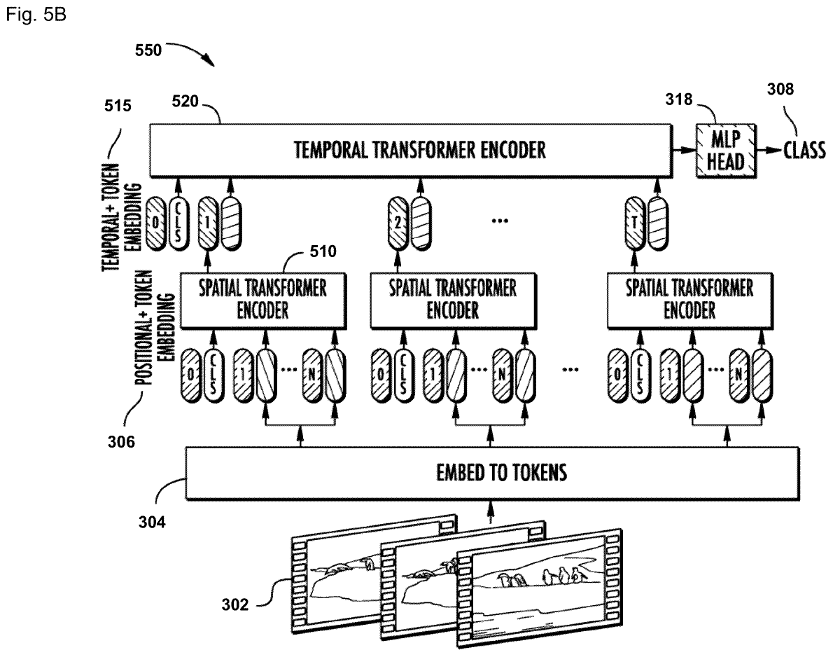

FIG. 5A depicts a block diagram of an example factorized encoder 500 according to example embodiments of the present disclosure. FIG. 5B depicts a block diagram of the factorized encoder discussed with reference to FIG. 5A incorporated into a video understanding model 550 including components discussed with reference to FIG. 3. The factorized encoder 500 can include two separate subencoders (e.g., transformers) in series including, for instance, a spatial transformer encoder 510 and a temporal transformer encoder 520. The spatial transformer encoder 510 can include one or more spatial transformer encoder layers 512. Additionally and/or alternatively, the temporal transformer encoder 520 can include one or more temporal transformer encoder layers 522. The spatial transformer encoder 510 can be configured to receive the plurality of video tokens 502 and produce, in response to receipt of the plurality of video tokens 502, a plurality of temporal representations 515. The temporal transformer encoder 520 can be configured to receive the plurality of temporal representations 515 and produce, in response to receipt of the plurality of temporal representations, a spatiotemporal representation of the video data, wherein the spatiotemporal representation is classified to produce the classification output. For instance, the spatial encoder 510 models interactions between tokens 502 extracted from the same temporal index. A token representation 515 for each temporal index (e.g., frame) is obtained from the spatial encoder 510. For instance, a representation 515 for each temporal index, hᵢ∈ [symbol] ^{d}, can be obtained from the spatial encoder 510 (e.g., after Lₛ layers 512). If prepended to the input, this can be equivalent to a classification token. Otherwise, this can be a global average pooling from the tokens output by the spatial encoder. The representations across different temporal indices can be aggregated into a single vector (e.g., representation 515. The temporal representations hi can be concatenated into a vector H∈ [symbol] ⁿ^{ᵢ}^{×d}.

Thereafter, the temporal encoder 520 models interactions between the representations 515. For instance, the temporal representations 515 can be forwarded through the temporal encoder 520 (e.g., including Lₜ layers 522) to model interactions between tokens 502 from different temporal indices. The output from the temporal encoder 520 can then be classified (e.g., by a classification model, such as a multi-layer perceptron model). In some implementations, the parameters of the spatial encoder 510 can be initialized from an image-pretrained model for faster training. This model can be significantly faster than other models (e.g., processing all tokens directly) especially as the sequence length of tokens increases, as it does not compute pairwise interactions between all input tokens. For instance, compared to the model that operates on all tokens directly, the factorized encoder 500 can include a greater number of transformer layers, but require fewer floating point operations (FLOPs) to compute.

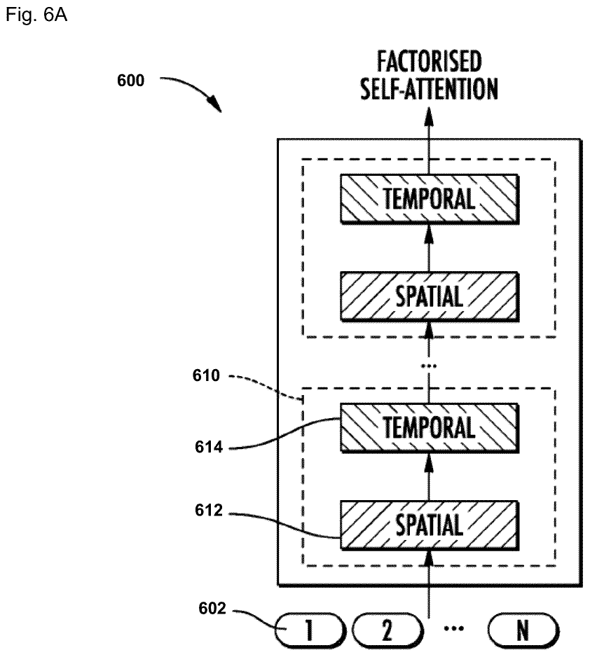

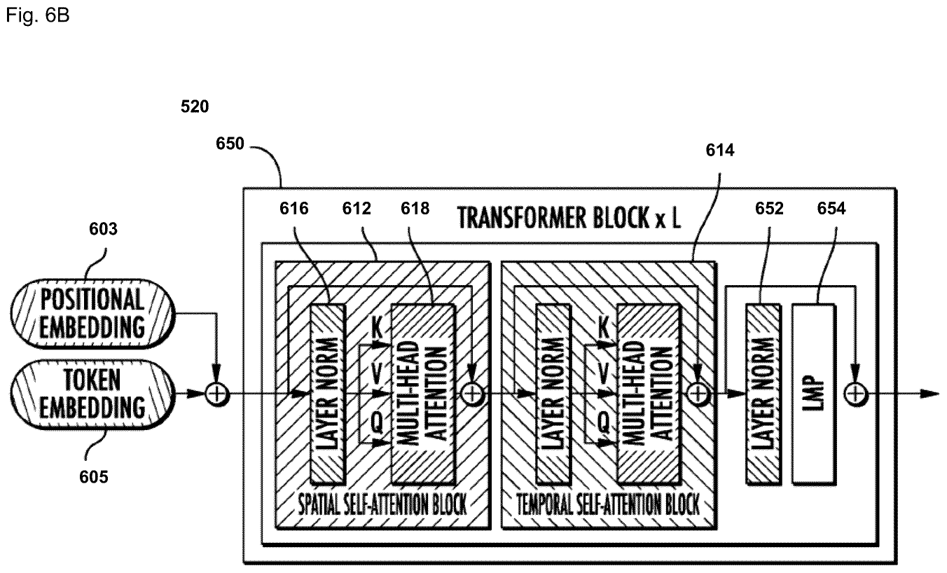

FIG. 6A depicts a block diagram of an example factorized self-attention mechanism 600 according to example embodiments of the present disclosure. The factorized self-attention mechanism 600 can include one or more self-attention layers 610. Each layer 610 can include a spatial self-attention block 612 configured to compute spatial self-attention among the plurality of video tokens 602 from a same temporal index. Additionally, each layer 610 can include a temporal self-attention block 614 configured to compute temporal self-attention among the plurality of video tokens 602 from a same spatial index. These computations may be performed sequentially in either order and/or in parallel. Factorized self-attention decomposes the multi-headed self-attention operation within a Transformer layer such that, at first, self-attention is only computed spatially. Thereafter, self-attention is only computed temporally. This can model spatiotemporal interactions more efficiently by factorizing the operation over two smaller sets of elements with comparable computational complexity.

In some implementations, the plurality of video tokens 602 are reshaped prior to being input to the factorized self-attention mechanism. For instance, the tokens 602 can be reshaped from [symbol] ^{1×n}^{ₜ}^{·n}^{ₕ}^{·n}^{_{w}}^{·d} to [symbol] ⁿ^{ₜ}^{×n}^{ₕ}^{·n}^{_{w}}^{·d}. Reshaping the tokens 602 can provide for more efficient computation.

FIG. 6B depicts a block diagram of an example factorized self-attention mechanism in an example transformer block 650 according to example embodiments of the present disclosure. As illustrated in FIG. 6B. the transformer block 650 can take as input tokens 602 (e.g., including positional embedding 603). The transformer block 650 can include a spatial self-attention block 612 and a temporal self-attention block 614. Additionally, the transformer block 650 can include a normalization layer 652 feeding a multi-layer perceptron layer 654. The spatial self-attention block 612 and the temporal self-attention block 514 can each include a normalization layer 616 and a multi-head attention mechanism 618.

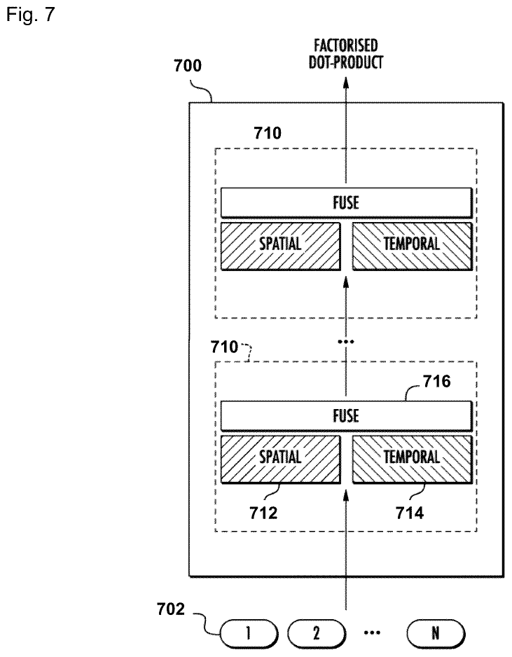

FIG. 7 depicts a block diagram of an example factorized dot-product attention mechanism 700 according to example embodiments of the present disclosure. The factorized dot-product attention mechanism 700 can include a plurality of layers 710. Each layer 710 can include a plurality of spatial attention heads 712 configured to compute attention weights for each of the plurality of video tokens 702 over a spatial dimension and a plurality of temporal attention heads 714 configured to compute attention weights for each of the plurality of video tokens 702 over a temporal dimension. In addition, each layer can include a fusion mechanism 716 configured to fuse the output from the spatial attention heads 712 and the temporal attention heads 714. For instance, in some implementations, outputs from the plurality of spatial attention heads 712 and the plurality of temporal attention heads 714 are combined by concatenation and linear projection. Factorized dot-product attention factories the multi-head dot-product attention operation within the transformer. As a result, the attention neighborhood for each token 702 is modified to only attend over spatial dimensions and temporal dimensions separately. For instance, the keys and values for each query can be modified to attend over tokens 602 from the same spatial and/or temporal index.

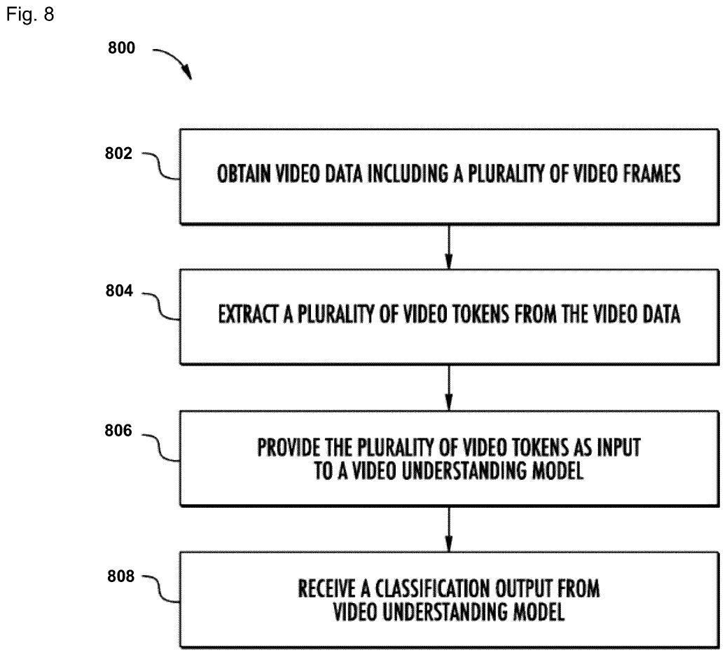

FIG. 8 depicts a flow chart diagram of an example method 800 for classifying video data with improved accuracy according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure. The method 700 can include, at 802, obtaining (e.g., by a computing system comprising one or more computing devices, video data. The video data can include a plurality of image frames. The image frames can depict one or more objects. For example, the video data can be a video captured by a mobile device, video camera, or any other suitable video capturing device. The video data can be stored in any suitable manner. For instance, the video data can be stored in computer-readable memory in any suitable format, such as a digital file format (e.g., a .mp4 file format, a .wav file format, etc.). Consider a video V∈ [symbol] ^{T×H×W×C}. For instance, in some implementations, the video data can include a number of image frames (e.g., T), a height (e.g., H), a width (e.g., W), and/or a number of channels (e.g., C). As an example, in some implementations, the video data can include 3 channels, such as a red channel, a green channel, a blue channel, and/or other color channels.

The method 800 can include, at 804, extracting (e.g., by the computing system) a plurality of video tokens from the video data. The video tokens can be a representation (e.g., an embedding representation) of spatiotemporal information of the video data. In some implementations, the plurality of video tokens being single-dimensional. The video tokens (e.g., the tubelets) may span a single frame t and/or a plurality of frames t. The video tokens (e.g., the tubelets) may be extracted from non-overlapping video data. For instance, a given portion of video data (e.g., a given pixel) may be represented exactly once in the plurality of video tokens (e.g., the tubelets). Additionally and/or alternatively, the video tokens (e.g., the tubelets) may span an entirety of the video data, such as the entire spatiotemporal volume defined by the video data. Processing a video can involve a large number of extracted tokens. Video understanding models according to example aspects of the present disclosure can be designed to process these video tokens, including a large number of video tokens.

For instance, in some implementations, the video tokens can be formed from “tubelets” having a length (e.g., l) and width (e.g., w) and spanning a number of video frames (e.g., t) that are then projected into a tensor representation (e.g., a d-dimensional vector). For instance, in some implementations, extracting the plurality of video tokens can include extracting (e.g., by the computing system) a plurality of video tubelets from the video data. According to example aspects of the present disclosure, N (e.g., non-overlapping) tubelets, xᵢ∈ [symbol] ^{t×h×w} can be extracted from the video data. Intuitively, this approach fuses spatiotemporal information during tokenization, which can be beneficial for improving video understanding.

For instance, the computing system can extract a plurality of tokens \tilde{z}∈ [symbol] ⁿ^{ₜ}^{×n}^{ₕ}^{×n}^{_{w}}^{×d} from tubelets of the video V∈ [symbol] ^{T×H×W×C}, where nₛ among dimension s is the number of tokens along the dimension (e.g.,

$$floor ( \frac{T}{t} ) , floor ( \frac{H}{h} ) , floor ( \frac{W}{w} ) ) .$$

In some implementations, the plurality of video tubelets are nonoverlapping. In some implementations, each of the plurality of video tubelets spans one of the plurality of video frames. In some implementations, each of the plurality of video tubelets spans two or more of the plurality of video frames. Furthermore, in some implementations, a length and/or width of the tubelets may be equivalent to and/or less than a length and/or width of the video data. For instance, in some implementations, a tubelet may be or may include a single (e.g., entire) frame. Smaller tubelets can result in more tokens, which can thus increase computational cost of processing the tokens. However, systems and methods described herein can nonetheless be capable of processing the tokens.

Additionally and/or alternatively, extracting the plurality of video tokens can include projecting, by the computing system, the plurality of video tubelets to a plurality of tensor representations of the plurality of video tubelets. As an example, the plurality of tubelets can be projected by linear projection (e.g., into an array or matrix). For instance, an array of tubelets having size:

$$floor ( \frac{T}{t} ) \times floor ( \frac{H}{h} ) \times floor ( \frac{W}{w} ) ) .$$

can be extracted from the video data.

Additionally and/or alternatively, extracting the plurality of video tokens can include merging (e.g., by the computing system) the plurality of tensor representations along at least one dimension to produce the plurality of video tokens. For instance, the array of tubelets can be compressed into a sequence of d-dimensional token representations by merging spatiotemporal dimensions. As one example, the tokens can be ordered in a single dimension based on frame index and/or position within the frame. This sequence of spatiotemporal tokens can then be passed through the video understanding model.

In some implementations, positional embeddings can be added to the sequence of tokens. As an example, in some implementations, positional embeddings are added to the plurality of video tokens and (e.g., subsequently) input to the video understanding model. For instance, this can assist permutation invariant models (e.g., transformers) with spatiotemporal understanding. As an example, once the positional embeddings are added, in some implementations, the tokens can be reshaped to obtain the input to the video understanding model.

The method 800 can include, at 806, providing (e.g., by the computing system) the plurality of video tokens to the video understanding model. The video understanding model can include a video transformer encoder model. The transformer encoder model can include an attention mechanism (e.g., a self-attention mechanism), at least one normalization layer and/or at least one multi-layer perceptron layer.

In some implementations, the video understanding model can process the entire sequence of tokens directly. For instance, in some implementations, the video understanding model includes a (e.g., nonfactorized) attention mechanism (e.g., self-attention mechanism), a normalization layer, and a multi-layer perceptron layer. The sequence of tokens (e.g., and/or position embedding(s), classification (CLS) token(s), etc.) can be input directly to this model. The video understanding model can thus model pairwise interactions between all pairs of spatiotemporal tokens in the input sequence. This approach can be computationally expensive, but achieves improved results on large datasets with ample training data. The parameters of this model can be initialized from an image-pretrained model for faster training and higher accuracy.

In some implementations, the video understanding model can include a factorized encoder. The factorized encoder can include two separate subencoders (e.g., transformers) in series. The factorized encoder can include, for instance, a spatial transformer encoder and a temporal transformer encoder. The spatial transformer encoder can be configured to receive the plurality of video tokens and produce, in response to receipt of the plurality of video tokens, a plurality of temporal representations. The temporal transformer encoder can be configured to receive the plurality of temporal representations and produce, in response to receipt of the plurality of temporal representations, a spatiotemporal representation of the video data, wherein the spatiotemporal representation is classified to produce the classification output. For instance, the first subencoder, referred to as the spatial encoder, models interactions between tokens extracted from the same temporal index. A token representation for each temporal index (e.g., frame) is obtained from the first subencoder. For instance, a representation for each temporal index, hᵢ∈ [symbol] ^{d}, can be obtained from the spatial encoder (e.g., after Ls layers). If prepended to the input, this can be equivalent to a classification token. Otherwise, this can be a global average pooling from the tokens output by the spatial encoder. The representations across different temporal indices can be aggregated into a single vector. The temporal representations hi can be concatenated into a vector H∈ [symbol] ⁿ^{ₜ}^{×d}.

Thereafter, a second subencoder, referred to as the temporal encoder, models interactions between these tokens. For instance, the vector can be forwarded through the temporal encoder (e.g., including Lt layers) to model interactions between tokens from different temporal indices. The output from the temporal encoder can then be classified (e.g., by a classification model, such as a multi-layer perceptron model) In some implementations, the parameters of the spatial encoder can be initialized from an image-pretrained model for faster training. This model can be significantly faster than other models (e.g., processing all tokens directly) especially as the sequence length of tokens increases, as it does not compute pairwise interactions between all input tokens. For instance, compared to the model that operates on all tokens directly, the factorized encoder can include a greater number of transformer layers, but require fewer floating point operations (FLOPs) to compute.

Additionally and/or alternatively, in some implementations, the video understanding model can include factorized self-attention. The factorized self-attention mechanism can include a first self-attention block configured to compute spatial self-attention among the plurality of video tokens from a same temporal index and a second self-attention block configured to compute temporal self-attention among the plurality of video tokens from a same spatial index. These computations may be performed sequentially in either order and/or in parallel. Factorized self-attention decomposes the multi-headed self-attention operation within a Transformer layer such that, at first, self-attention is only computed spatially. Thereafter, self-attention is only computed temporally. This can model spatiotemporal interactions more efficiently by factorizing the operation over two smaller sets of elements with comparable computational complexity.

In some implementations, the plurality of video tokens are reshaped prior to being input to the factorized self-attention mechanism. For instance, the tokens can be reshaped from [symbol] ^{1×n}^{ₜ}^{·n}^{ₕ}^{·n}^{_{w}}^{·d} to [symbol] ⁿ^{ₜ}^{×n}^{ₕ}^{·n}^{_{w}}^{·d}. Reshaping the tokens can provide for more efficient computation.

The parameters of the spatial transformer can be initialized from an image-pretrained model. Additionally and/or alternatively, the parameters of the temporal transformer can be initialized as a vector of zeros. This can accelerate training and/or improve overall model performance. The factorized self-attention mechanism can include the same number of transformer layers as the model that operates on all tokens. However, the number of parameters does increase due to the additional self-attention layer. In some implementations, a classification token is not used as part of the input in this model to avoid ambiguities when reshaping the input tokens between spatial and temporal dimensions.

Additionally and/or alternatively, in some implementations, the video understanding model can include factorized dot-product attention. The factorized dot-product attention mechanism can include a plurality of spatial attention heads configured to compute attention weights for each of the plurality of video tokens over a spatial dimension and a plurality of temporal attention heads configured to compute attention weights for each of the plurality of video tokens over a temporal dimension. Factorized dot-product attention factories the multi-head dot-product attention operation within the transformer. As a result, the attention neighborhood for each token is modified to only attend over spatial dimensions and temporal dimensions separately. For instance, the keys and values for each query can be modified to attend over tokens from the same spatial and/or temporal index. A first half of attention heads can attend over tokens from the spatial dimensions and a second half of attention heads can attend over the temporal dimension. In some implementations, outputs from the plurality of spatial attention heads and the plurality of temporal attention heads are combined by concatenation and linear projection.

In some implementations, this model may not add any parameters compared to an image-pretrained model, and thus can be initialized directly from it. The factorized dot-product attention can provide a comparable number of parameters to the model that operates directly on all tokens while having comparable computational complexity to the factorized self-attention and factorized encoder. Note that these embodiments are not mutually exclusive, and a given video understanding model may include none or any other combination of a factorized encoder, factorized self-attention and/or factorized dot-product attention.

The method 800 can include, at 808, receiving (e.g., by the computing system) a video understanding output from the video understanding model. For instance, in some implementations, the video understanding output can be a video classification output. The video classification output can include data indicative of the video data belonging to at least one class of a plurality of candidate classes. For instance, in some implementations, the video understanding model can output, as the video classification output, a plurality of logit scores respectively associated with the plurality of candidate classes. The logit scores can be indicative of a likelihood, probability, confidence, etc. that the video data belongs to the respective candidate class.

In some implementations, the classification output can be averaged across multiple sets of video data to achieve a final classification output. For instance, in some implementations, longer video segments can be split into multiple views, and each view can be separately input into the video understanding model. The output (e.g., logits) per view can be averaged together to produce a final output for the longer video segments. For instance, the classification output can include, for each candidate class of the plurality of candidate classes, a logit score respectively associated with the candidate class, where the logit score is indicative of a probability or confidence that the video segment described by the video data is properly classified by the candidate class. In some implementations, the logit scores can be one-hot such that, for a given classification output, a single logit score may be nonzero, with all other logit scores having zero values. In some implementations, the logit scores may be discrete values (e.g., 0 or 1). In some implementations, the logit scores may range from a minimum value (e.g., 0) to a maximum value (e.g., 1).

Additionally and/or alternatively the classification output may be or include a word or phrase descriptive of at least a portion of a video segment described by the video data. For instance, in some implementations, the classification output can be a phrase of one or more words that is descriptive of a subject of the video segment, such as object(s) depicted in the video segment, action(s) performed or described in the video segment, topic(s) included in the video segment, and/or other suitable subjects. As an example, in some implementations, the word or phrase can be output directly from the video classification model. As another example, in some implementations, each candidate class of the plurality of candidate classes (e.g., each logit score) can have a respectively associated word or phrase.

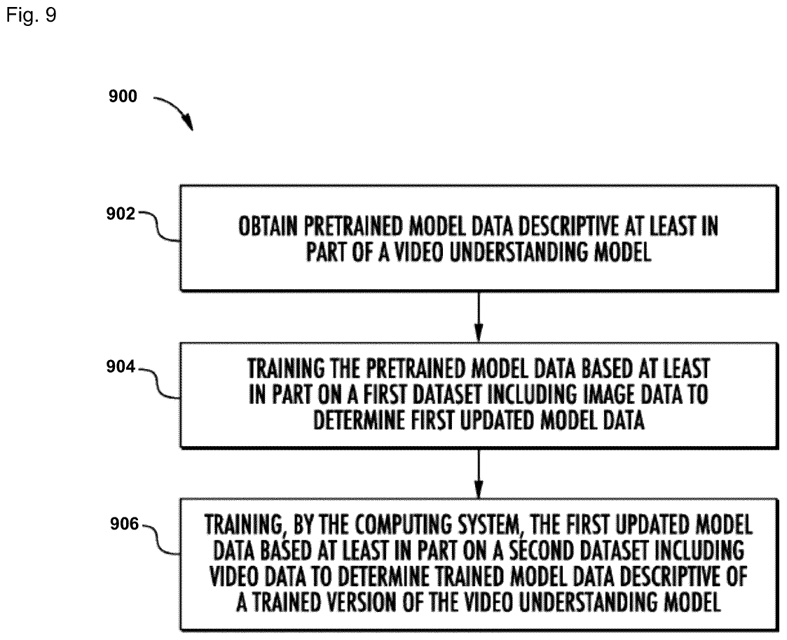

FIG. 9 depicts a flow chart diagram of an example method 900 for training a video understanding model for classifying video data with improved accuracy according to example embodiments of the present disclosure. Although FIG. 9 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

The method 900 can include, at 802, obtaining (e.g., by a computing system comprising a plurality of computing devices) pretrained model data descriptive at least in part of a video understanding model. The video understanding model can include at least one parameter of a video transformer encoder model. For instance, the pretrained model data may be descriptive of an image understanding model (e.g., an image classification model) that may be at least partially repurposed (e.g., may have at least one directly transferable parameter) such that the model can be converted to a video understanding model according to example aspects of the present disclosure.

The method 900 can include, at 904, training (e.g., by the computing system) the pretrained model data based at least in part on a first dataset, the first dataset comprising image data. to determine first updated model data. For instance, the first dataset can be an image dataset. The model can be trained using the first dataset. Generally, image datasets are more widely available than video datasets, and can be useful in partially training a video understanding model.

The method 900 can include, at 906, training (e.g., by the computing system) the first updated model data based at least in part on a second dataset, the second dataset comprising video data. to determine trained model data descriptive of a trained version of the video understanding model. For instance, the second dataset can be a video dataset. The second dataset may have comparatively smaller amounts of training data (albeit more closely related to the video classification task) than the first dataset, such as due to a lack of available training data (e.g., for the video classification task). Subsequent to being trained using the first dataset, the model can be trained using the second dataset.

For instance, one challenge present in the use of video data with machine-learned (e.g., transformer-based) model architectures is that many architectures can require large corpuses of training data to effectively train the model(s). For instance, many architectures operating on image data can be trained using large datasets such as ImageNet 21K, HT, etc. such that the model(s) can be trained to an acceptable degree. However, generation of video datasets at this scale can be costly, and, as such, comparably-sized datasets generally do not exist for video data. For some machine-learned model architectures. especially those having inductive biases (e.g., convolutional models), this challenge may not be detrimental to use of the model. For some models lacking inductive biases (e.g., transformer models), this can complicate use of the model unless a sufficiently sized dataset is available. For instance, transformer models may only provide effective predictions when trained on large-scale datasets. Currently, even the largest video datasets such as Kinetics have several orders of magnitude fewer labeled examples than corresponding image datasets. As a result, training large models from scratch to high accuracy can be prohibitively challenging. To solve this problem, example aspects of the present disclosure provide for initializing the models described herein from pretrained image models. Example aspects of the present disclosure are directed to effective strategies for leveraging pretrained image models to initialize large-scale video understanding models, such as on how to initialize parameters that may be incompatible with image models.

For instance, in some implementations, a position embedding is added to each input token. However, video models can have many more tokens (e.g., nₜ times more tokens) than image models (e.g., from having t frames). As a result, to initialize the positional embedding, it can be beneficial to repeat the token temporally over each frame. Therefore, at initialization, all tokens with the same spatial index can have the same embedding, which can then be fine-tuned.

As another example, in some implementations, the tubelet embedding filter may be a three-dimensional tensor compared to a two-dimensional tensor in an image model (e.g., due to the temporal dimension). One approach to initialize the three-dimensional filter from the two-dimensional filter is to inflate it by replicating the filter along the temporal dimension and averaging them. Another approach, termed “central frame initialization”, includes initializing the filter with zeroes along all temporal positions except at the temporal center. In this case, the filter can effectively behave like frame sampling at initialization while still having the capability to learn to aggregate temporal information from multiple frames as training progresses.

As another example, in some implementations, the factorized self-attention transformer block can include two multi-headed self-attention (MSA) modules, where a standard image model may include only one MSA module. Thus, in some implementations, the spatial self-attention model can be initialized from the pretrained module and the temporal self-attention model can be initialized with zeroes. In this case, the model behaves as a residual connection at initialization.

### External Object Detection

In view of this baseline spacetime video vision transformer, enhancements involving external object detection are now discussed. This includes how one of both of object-guided token sampling and an object-aware attention model may be employed.

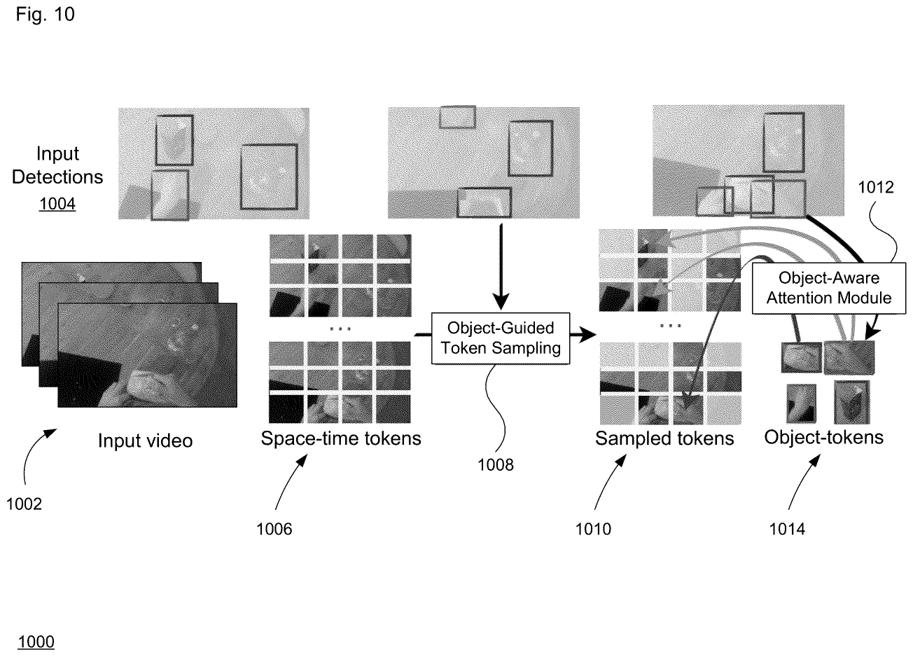

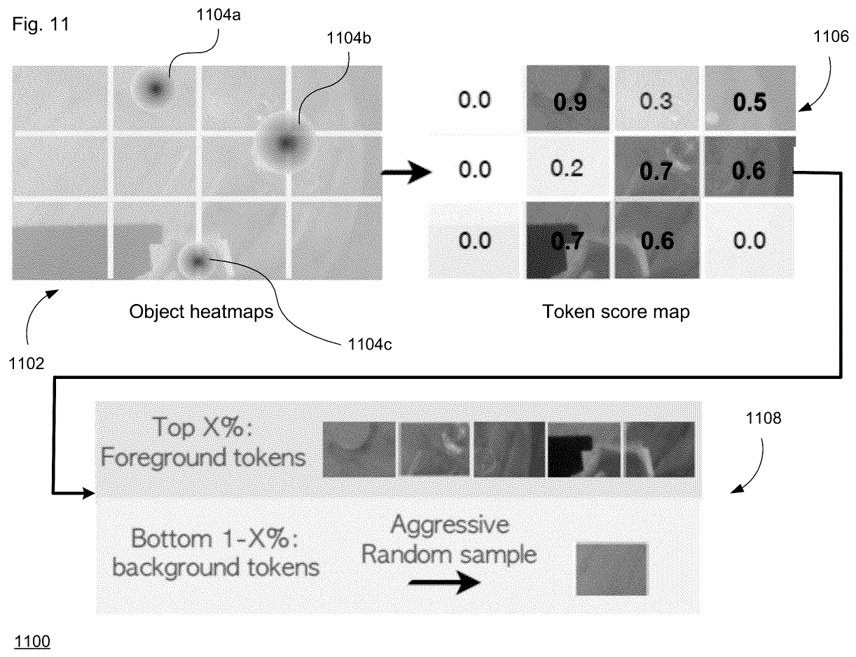

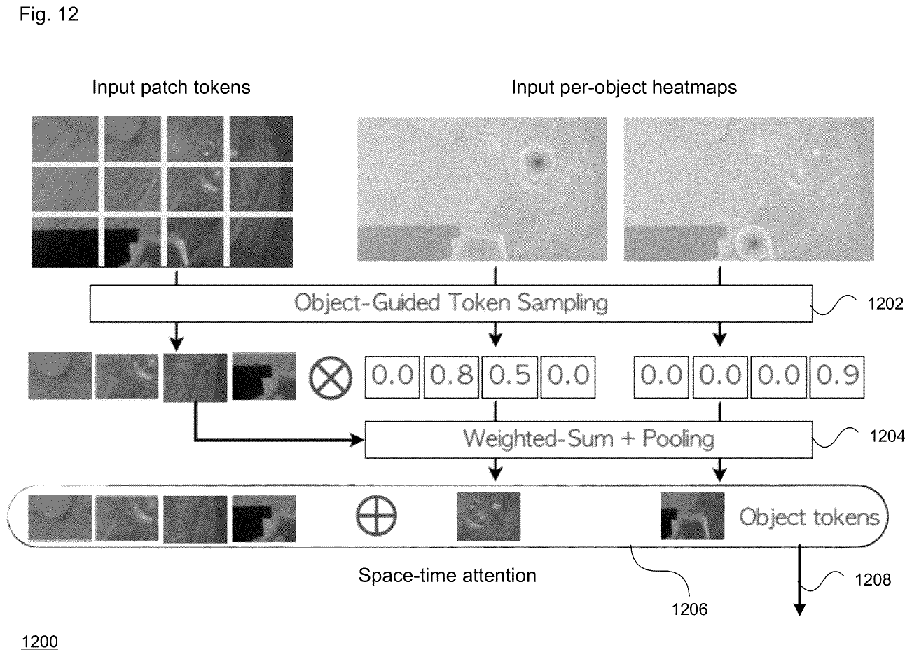

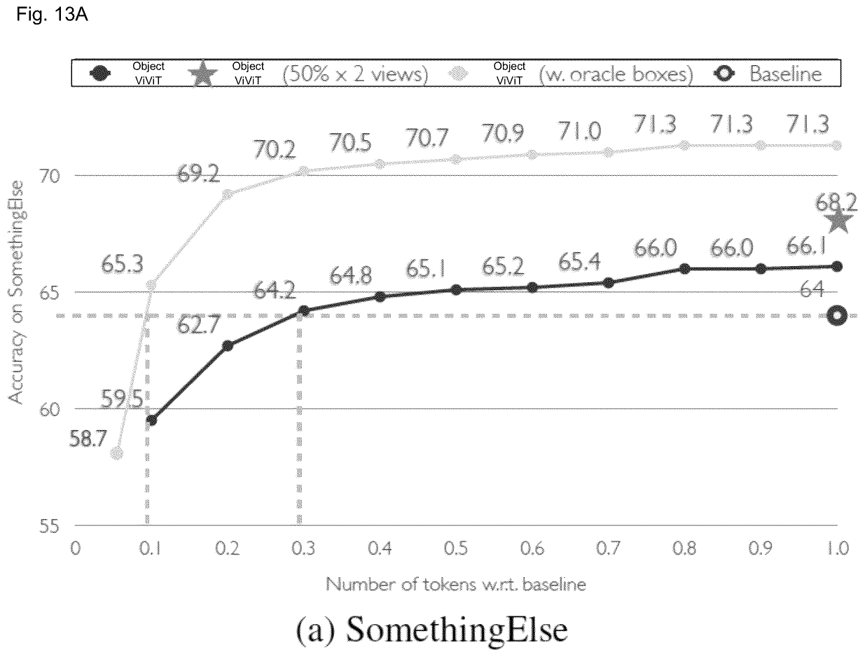

An overview of these enhancements is illustrated in example 1000 of FIG. 10. Based on an input video 1002, the system takes raw video pixels and input object detections 1004 (e.g., bounding boxes) as input, and runs space-time attention on video patch tokens 1006. The detection boxes may be used in two ways. First, the system can use object locations to downsample the patch tokens before running transformers (see Object-Guided Token Sampling at block 1008, discussed in more detail below with regard to FIG. 11). This creates a set of sampled tokens 1010. Second, the system can run a customized attention module 1012 that creates object tokens 1014 from object-patch relations and uses them to enhance patch features (see Object-Aware Attention Module 1012. discussed in more detail with regard to FIG. 12).

More particularly, this object-guided token sampling strategy uses object locations to identify foreground and background tokens. Relevant foreground tokens are retained by the system as is, while background tokens can be aggressively downsampled before forwarding them to the transformer module, such as the video vision transformer examples discussed above. And to fully leverage the relation between objects and the unstructured spatial-temporal patches, the object-aware attention module can also be employed. This attention module first creates object tokens by grouping patch tokens from the same object using an object-weighted pooling, and then applies space-time attention on the concatenated object and patch tokens. This way, patch features are augmented with their related object information. As noted above, object-guided token sampling and the object-aware attention module features are complementary. They can be used individually to improve either token-compactness or accuracy, or can be used together to gain benefits of both.

Experiments to test these approaches with known datasets (e.g., SomethingElse, Something-Something, and Epic Kitchens) shows that with object-guided token sampling, the system can process 60% to 90% of the input tokens without losing any accuracy. And by using the object-aware attention module alone, the system may outperform a baseline video vision transformer by 0.6 to 2.1 points. Combining both object-related modules is shown to improve token-compactness and accuracy even further, matching baseline performance by processing 30%, 40%, and 60% of the input tokens for the SomethingElse, Something-Something, and Epic Kitchens datasets, respectively. And under the same number of processed tokens but with a higher temporal resolution, the model with dropped tokens has been shown to improve upon baselines by up to 4.2 points. These experiments and results are detailed further below.

Given a video V represented as a stack of pixels V∈ [symbol] T×H×W×3, action classification aims to classify the video into one of the pre-defined action categories c∈ [symbol] . The object-based framework is implemented in conjunction with the space-time video vision transformer discussed above. The video vision transformer approach first divides video pixels V into nonoverlapping space-time tokens, where each token represents a pixel tube in size (dt, dh, dw). This gives

$$N = ⌊ \frac{T}{d t} ⌋ \times ⌊ \frac{H}{d h} ⌋ \times ⌊ \frac{W}{d w} ⌋$$

tokens.

The RGB pixels inside each token are then mapped to a fixed dimension D by a linear layer, followed by adding positional embeddings. As a result, the input to the transformer is z₀=[z₁, z₂, . . . , z_{N}], where z₁> [symbol] ^{D} is a patch token. Each transformer layer updates the tokens z with multi-head attention (MHA) and an MLP:

$${y}^{l} = MHA ( {z}^{l} {z}^{l} {z}^{l} ) + {z}^{l}$$

$${z}^{l + 1} = MLP ( {y}^{l} ) + {y}^{l} .$$

where MHA (q, k, v) computes attentions between queries q, keys k, and values v. In this scenario, MLP contains 2 linear layers with layer norm omitted for simplicity. The output classification logits c∈ [symbol] ^{|C|} is obtained after a linear layer on global average-pooled features of all tokens in the last layer.

Besides video pixels V. the framework takes an additional input: object detections

$$\{ \{ ( {b}_{t , o} , {δ}_{t , o} ) \} \frac{{n}_{t}}{o = 1} \} \frac{T}{t = 1} , where {b}_{t , o} = ( {x}_{t , o} , {y}_{t , o} , {w}_{t , o} , {h}_{t , o} )$$

is the bounding box of the o-th object in frame t, δ_{t,o} is an optional object identity (when tracking is enabled), and nₜ is the number of objects in frame t. The bounding boxes may be obtained from an off-the-shelf object detector (see. e.g., “Faster r-cnn: Towards real-time object detection with region proposal networks” by Ren et al, 2015, which is incorporated herein by reference), or can be oracle boxes from annotation for analytic benchmarks (see, e.g., “Something-else: Compositional action recognition with spatial-temporal interaction networks” by Materzynska et al, 2020, which is incorporated herein by reference).

### Object-Guided Token Sampling

According to one aspect of the technology, the system first uses objects [symbol] to downsample input tokens z⁰. FIG. 11 illustrates an example 1100 overview of this process. As shown at 1102, the system first renders the object detections as center heatmaps (e.g., 1104a, 1104b and 1104c. After tokenization, the system defines the “object-scores” of each token as the sum of the heatmap values inside it, as shown at 1106. The tokens with top X % scores are defined as foreground, where the value for X is a configurable parameter, and the rest of the tokens (1-X %) are deemed to be background. All such foreground tokens are maintained, while the system may aggressively downsample the background tokens as shown at 1108. This mechanism automatically prioritizes object coverage as all object centers have the highest score.

A main insight is that tokens which are inside objects carry the motions in the scene and should be retained, while tokens in the background are mostly static and can be partially dropped due to their redundancy. The dropping ratio is configurable to be able to control the token-accuracy trade-off. To do so, a continuous token “objectness” score can be defined by measuring how close each token is to object centers.

Specifically, objects may be rendered in each frame into a single class-agnostic center heatmap Hₜϵ [symbol] ^{H×W} in the original image resolution, where:

$${H}_{t , i , j} = {maxexp}_{o \leq {n}^{t}} ( - \frac{{( i - {x}_{t , o} )}^{2} + {( j - {y}_{t , o} )}^{2}}{2 {σ}_{t , o}^{2}} ) ,$$

and σ_{t,o} is a monotonic function of the object size that controls the Gaussian radius. The same tube size (dt, dh, dw) is used to project the heatmap into tublets \tilde{H}∈ [symbol] ^{N}.

The system may select the top X % of the tokens according to the objectness score \tilde{H}:

$${z}_{f ℊ}^{0} = \{ {z}_{n} \vert {\tilde{H}}_{n} \geq τ \} , {z}_{b ℊ}^{0} = {z}^{0} - {z}_{f ℊ}^{0}$$

where τ is the X %-th value of \tilde{H}, and X is a configurable parameter to control the number of tokens. “fg” indicates foreground, while “bg” indicates background.

With this foreground/background definition, the system keeps all the foreground tokens as is, and uniformly samples background tokens

$${\hat{z}}_{b ℊ}^{0} , where \vert {\hat{z}}_{b ℊ}^{0} \vert = Y \% xN .$$

The final inputs may be a concatenation of both tokens:

$${\hat{z}}^{0} = [ {z}_{f ℊ}^{0} , {\hat{z}}_{b ℊ}^{0} ]$$

The system therefore has |\hat{z}⁰|=(X+Y) %× N remaining tokens.

### Object-Aware Attention

The system may use objects [symbol] in transformer blocks to improve features in an object-aware attention approach. An example 1200 of this is illustrated in FIG. 12. The inputs to the object-aware attention module are (downsampled) space-time patch tokens together with their object-scores with respect to each object instance, as shown at 1202. FIG. 12 shows only one frame for clarity. For each object instance at each frame, the system creates a new object token by weighted pooling between the pixel features and the object weights (as shown by the ⊗ operator). The system then concatenates (as shown by the ⊕ operator) the object tokens and patch tokens at 1204 and conducts space-time attention over all tokens at 1206. The space-time attention may be performed as described in “Object-region video transformers” by Herzig et al. (2022), the entire disclosure of which is incorporated by reference herein. The object-aware attention module outputs updated features of patch tokens as shown by arrow 1208, which are enhanced by object information.

More particularly, objects are represented in a frame as a center-heatmap. Here, the system uses instance-specific heatmaps. In particular, for each object o in frame t, the system renders a heatmap H_{o,t}∈ [symbol] ^{H×W} with a single Gaussian peak:

$${H}_{o , t , i , j} = exp ( - \frac{{( i - {x}_{t , o} )}^{2} + {( j - {y}_{t , o} )}^{2}}{2 {σ}_{t , o}^{2}} )$$

Each H_{o,t} highlights the pixel regions of object o in frame t. After tokenization and the token-sampling following the equation for H_{t,i,j}, the downsampled per-instance heatmap Ĥ_{o,t} represents the affinity score between object o and each remaining token in frame t. These affinity scores naturally serve as weighting scores to aggregate object features, and the system directly uses them to create object tokens w_{o,t} for each object at each frame. In particular:

$${w}_{o , t}^{l} = MaxPool ( MLP ( {\hat{H}}_{o , t} * {z}_{t}^{l} ) ) ,$$

where l is the transformer layer index,

$${z}_{t}^{l}$$

is the (downsampled) patch tokens of frame t at layer 1, and MLP are two linear layers. Optionally, when object identity information is available (through tracking), the system may encode object identity via a learnable identity embedding eₒ∈ [symbol] ^{D} shared across time:

$${w}_{o , t}^{l} = {w}_{o , t}^{l} + {e}_{o}^{l} .$$

The process next concatenates the object tokens and the (downsampled) patch tokens and keys and values, and use them to update the query patch tokens as follows:

$${y}^{l} = MHA ( {z}^{l} , [ {z}^{l} , {w}^{l} ] , [ {z}^{l} , {w}^{l} ] ) + {z}^{l}$$

It has been observed that inserting the object tokens at 3 layers (e.g., the 2, 6, 11-th layer) of the transformer is sufficient. All other layers may use the self-attention in y^{l}=MHA(z^{l}z^{l}z^{l})+z^{l}.

### Experimental Results

The above-described techniques were evaluated on the dataset Something-something v2 (see, e.g., “The something something video database for learning and evaluating visual common sense” by Goyal et al., 2017), SomethingElse (see, e.g., “Something-else: Compositional action recognition with spatial-temporal interaction networks” by Materzynska et al., 2020), and Epic Kitchen (see, e.g., “The epic-kitchens dataset: Collection, challenges and baselines” by Damen et al., 2020), the discussions of which are each incorporated herein by reference.

Something-something v2 (or “SSv2”) is a large-scale action classification dataset with approximately 169,000 training videos and approximately 25,000 validation videos. The videos are 2-4 seconds long, focusing on hand-object interaction actions, with a total of 174 action classes. The action classes are agnostic to object classes.

Something-Else is a re-split of SSv2 videos, with a focus on compositional action recognition regardless of object classes. It ensures object classes of the same action are disjoint between training and validation. The resulting split has approximately 55,000 training videos and approximately 67,000 validation videos. The videos are decoded in 12 FPS. Something-Else additionally annotated ground-truth object bounding boxes with tracked identities for videos in its split. In analytic experiments, these oracle box annotations were used to study the performance upper-bound of our framework. In certain experiments, bounding boxes were inferred according to a finetuned FasterRCNN detector with ResNet-101 backcbone on the corresponding splits of the SomethingElse box annotations.

Epic-Kitchens contains approximately 67,000 training videos and approximately 10,000 validation video segments on kitchen scenes, where each segment is on average 3 seconds long. The action is composed of a verb (from 97 classes) and a noun (from 300 classes), and is considered as correct if both verb and noun classification are correct. The dataset does not provide bounding box annotations, so an off-the-shelf object detector was trained on hand-object interaction dataset, and a learning-free tracker SORT was used to link them. The videos here were decoded at 60 FPS.

For the testing results presented herein, the system was implemented in JAX (see, e.g., “JAX: composable transformations of Phython+NumPy programs” by Bradbury et al, 2018) based on the Scenic library (see, e.g., “A jax library for computer vision research and beyond” by Dehghani et al., 2022). The space-time video vision transformer described above was used with VideoMAE pretraining (see, e.g., “Masked autoencoders are data-efficient learners for self-supervised video pretraining” by Tong et al., 2022) as the baseline model. In all experiments, an input size of (16, 224, 224) was used, and token cube size of (2, 16, 16) was used, which results in an input size of 1568 tokens. The training hyper-parameters follow Video-MAE finetuning. Specifically, the model and baselines were trained using the AdamW optimizer (see, e.g., “Adam: A method for stochastic optimization” by Kingma et al, 2015) with learning rate 10-3 and batch size of 256 videos with a cosine learning rate decay. During training, images were resized to short side 256 and with a random crop at 224. Unless specified, during testing the image was resized to short side 224, and with a single center crop. Uniform frame sampling was used according to VideoMAE and TSN (see, e.g., “Temporal segment networks for action recognition in videos” by Wang et al, 2018). In other words, the sampling stride is proportional on the video length so that the sampled frames always cover the whole video. Regularizations were used including drop path of 0:1, label smoothing of 0:1, and mixup of 0:8. On SSv2, VideoMAE checkpoint pretrained was loaded on the SSv2 training set, and the ObjectViViT model was trained for 30 epochs. On SomethingElse and Epic Kitchens, the system initialized from the VideoMAE checkpoint pretrained on Kientics400 (see, e.g, “The kinetics human action video dataset” by Kay et al, 2017), and the model was trained for 50 epochs. All other training parameters are the same between datasets.

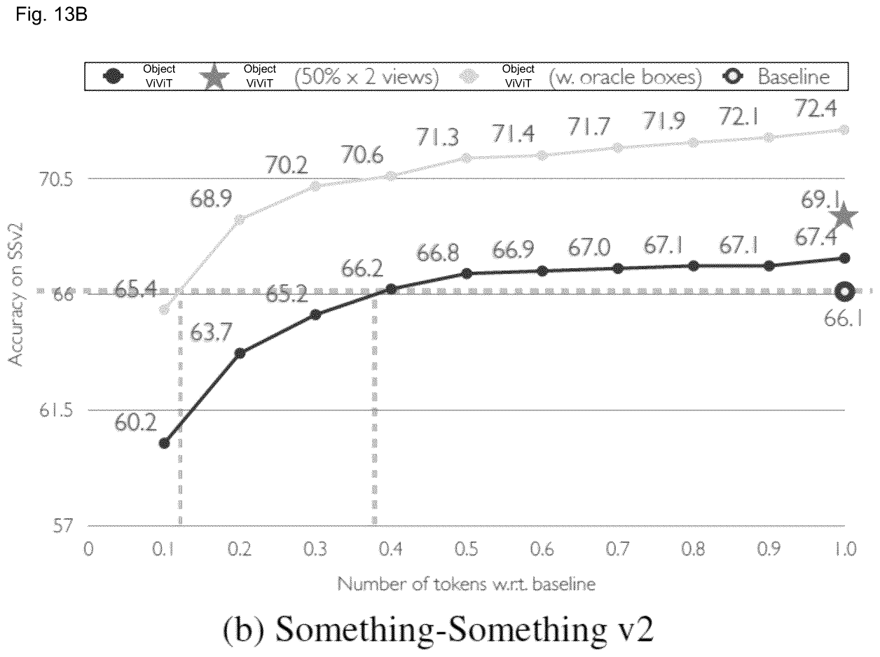

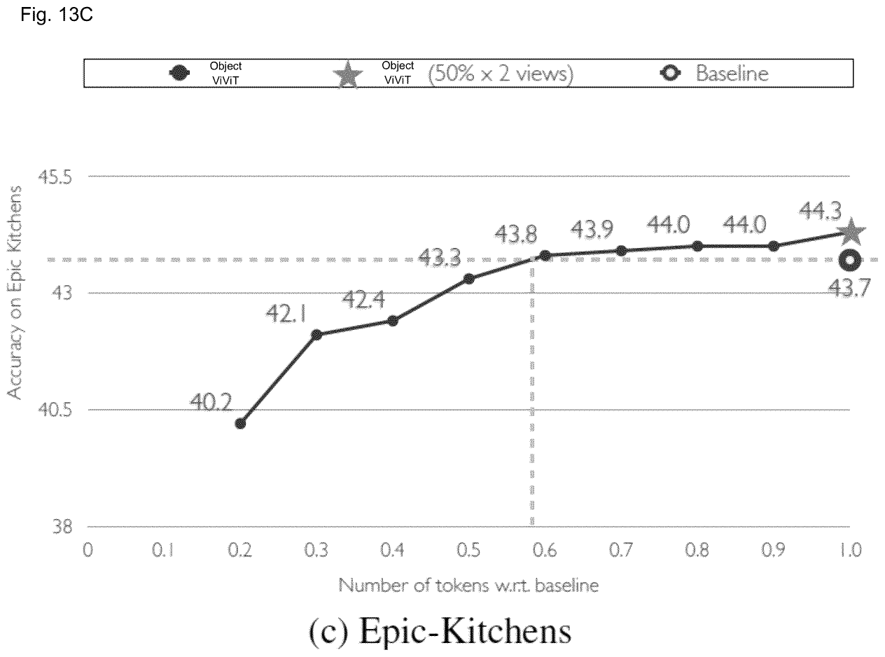

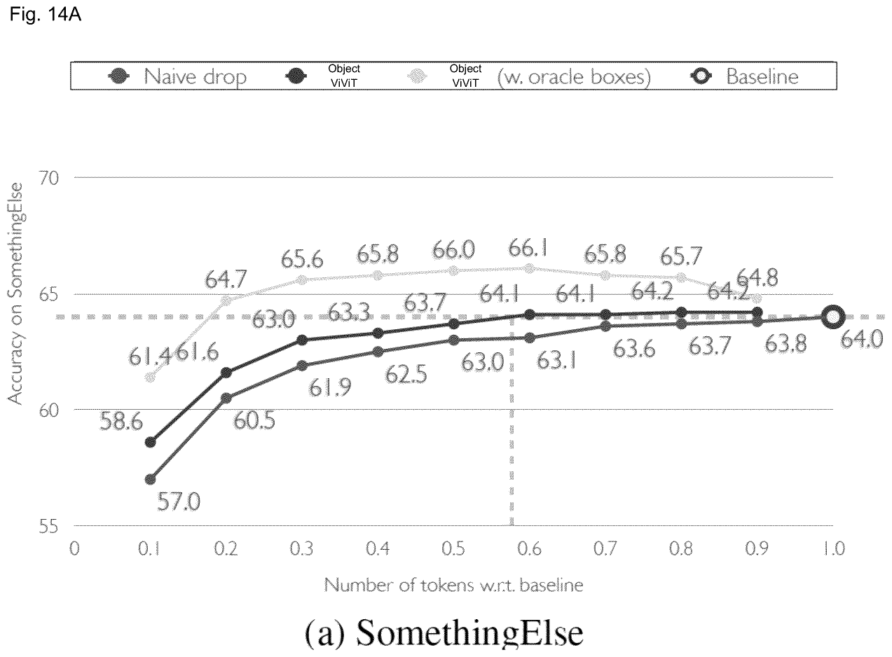

FIGS. 13A-C present action classification results with both object-aware attention module and object-guided token sampling (collectively referenced as ObjectViViT) under different numbers of sampled tokens ((X+Y) %, the ratio with respect to all tokens) on SomethingElse (a), SSv2 (b), and Epic Kitchens (c) dataset. Results are shown with inferred boxes from detectors ((ObjectViViT)) or with oracle boxes. The baseline uses the space-time video vision transformer discussed above with VideoMAE pretraining. The models were evaluated under single-crop and single-view testing by default. Using all tokens (x-axis at 1.0), it can be seen that object-aware attention improves the baseline by 0.6 to 2.1 points. With fewer tokens, the present model (ObjectViViT) matches the baseline performance with 30%, 40%, and 60% of tokens on the three datasets, respectively. An optimal model (shown with the ★ symbol) with 50% tokens and 2-view testing is shown to achieve better accuracy than the full model under the same number of processed tokens. It can be seen that with ground truth boxes, only need 10% tokens are needed to match the baseline's performance.

More particularly, the hyperparameters of the present model include the foreground token split ratio X % and the background sampling ratio Y %. Here, the background sampling ratio Y %=10% (except for 10% total tokens where Y %=5%), and sweep X % so that the total number of remaining tokens (X+Y) % range from 10% to 90%. For the results of 100% tokens, only OAM was used. It can be observed that without dropping tokens (x-axis at 1.0), OAM effectively boosts the space-time ViViT baseline by a healthy margin, with 2.1%, 1.3%, and 0.6% points improvements on the three datasets, respectively. For analysis purposes, results are also shown with the ground truth detections (in both training and testing) when available. Here the improvements further increase to 7.3% and 6.3% on SomethingElse and SSv2, respectively. This implies the performance can be further improved with stronger detectors.

When starting dropping tokens using OGS, the performance of the model decreased due to dropped input information. The performance drops mildly with respect to tokens, and overall yields a favorable trade-off. Specifically, on SomethingElse, SSv2, and Epic-Kitchens, the present model meets the baseline's performance at 30%, 40%, and 60% tokens, respectively. This convincingly shows object regions are right highlights of the videos and can effectively guide token selection. Again for analysis purposes, when ground truth bounding boxes are available, the present approach can match the baseline performance with only 10% tokens. As the present model saves tokens in inference, a testing strategy was configured that applies a 50%-token model with 2-view testing (in other words, uniform sampling frames with different starting frames and averaging output logits) so that the overall number of tokens processed matches the baseline.

To evaluate the effectiveness of object-guided sampling, certain testing applied only OGS without OAM o study the importance of the sampler alone. Following the settings in described above with respect to FIGS. 13A-C, the foreground token split ratio X % was varied and the action classification change of the three datasets was obtained. These results were compared to a naïve token dropping baseline that uniform-randomly drop tokens in space and time, which is equivalent to setting X %=0 and varying Y % in our framework, and is the same as the token sampler used in video MAE pretraining.

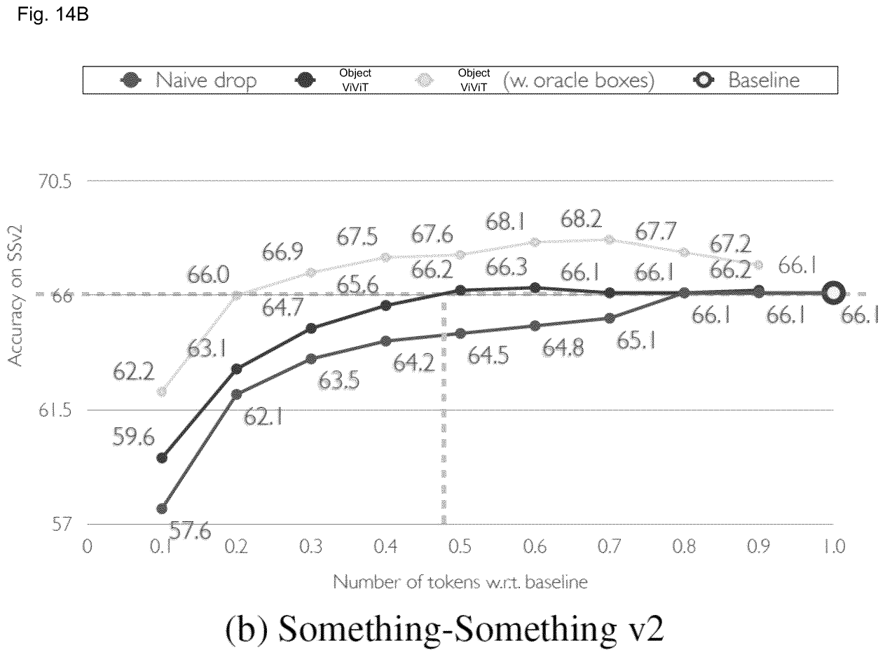

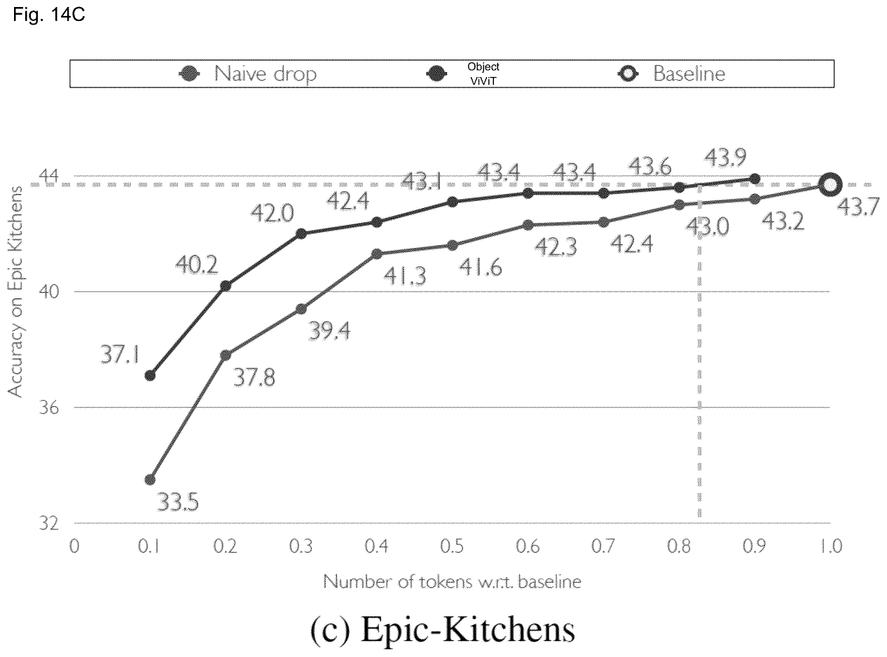

FIGS. 14A-C shows these action classification accuracy results on SomethingElse (a), SSv2 (b), and Epic Kitchens (c) datasets. It can be seen that the present object-guided sampling approach consistently outperforms the naive sample baseline on all sampling ratios and datasets. It can be observed that token-sampling alone can improve action-recognition performance on SomethingElse and SSv2 (with both inferred or oracle boxes), and matches the baseline performance with about 50%-60% number of tokens.

More particularly, on all three dataset and all sampling ratios, the object-guided sampler outperforms the uniform sampling baseline, with a more significant gain when the total sampling ratio is low. Solely dropping tokens can improve action classification accuracy for free. In these results on all the three datasets, a 0.2 point gain is observed on their corresponding optimal sampling ratio. This may be the result of dropping background tokens highlights the foreground motions, which makes the learning task easier. This phenomenon was more pronounced when oracle detections were used, where a 2.1% gain was observed on both Something datasets. The performance improvements do not increase with more tokens, as 100% tokens go back to the no-sampling baseline. Most importantly, on all the three datasets, the OGS approach matches the full-token baseline with fewer tokens, with 60%, 50%, 90% tokens, respectively.

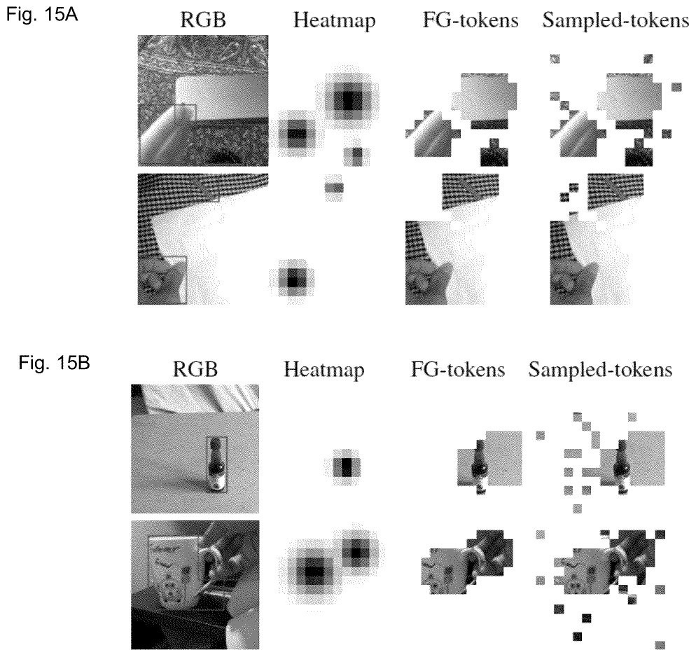

FIGS. 15A-B show qualitative results of object-guided token sampling. The rows in each figure shows one frame from different videos (here, two different videos in each of FIGS. 15A and 15B). From left to right, are the original RGB pixels with external bounding boxes, the object-heatmap used to label tokens, the resulting foreground tokens, and the overall sampled tokens including background. The foreground split ratio X=30% and background sample ratio Y=10% were used.

Additional testing involved ablation studies to evaluate the importance of background tokens, when to apply token sampling, etc.

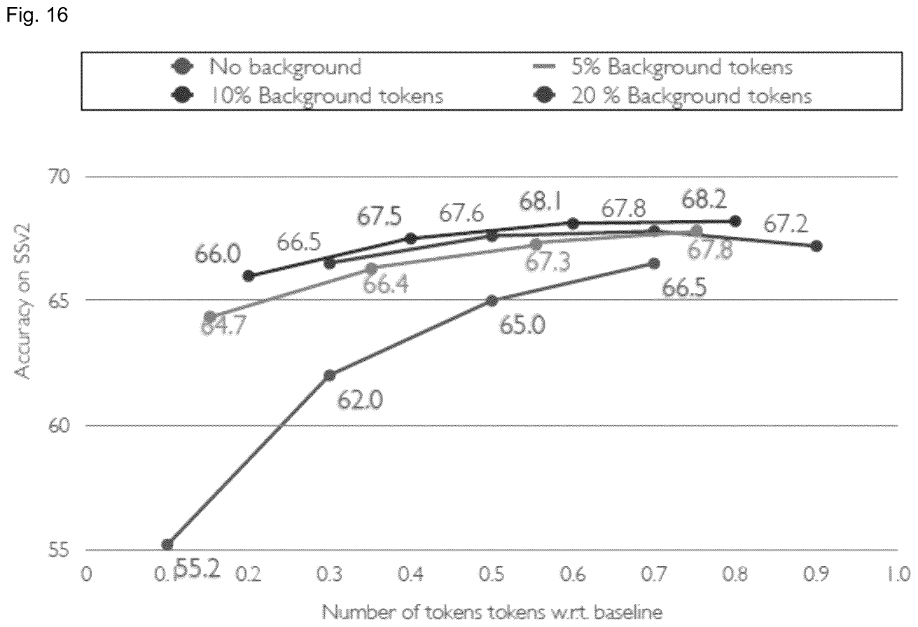

FIG. 16 illustrates that it is highly beneficial to include both objects and contexts, illustrating the accuracy trade-off under different amounts of background tokens on SomethingSomeghing-V2 (with ground truth bounding boxes). Action recognition accuracy is presented under different numbers of remaining tokens ((X+Y) % in x-axis) with different amounts of background tokens (different Y % in different lines). The entry without any background tokens is seen to significantly underperform other entries even with very few background tokens (5%). This is because non-object tokens provide important contextual information that might be critical for the object, e.g., showing the action is happening on a desk or a dining table. Background tokens also prevent the model from overfitting into inaccurate object detection or annotation. Experiments show including 10% background tokens gives an overall good trade-off, but different foreground-background token split ratios do not crucially impact the results.

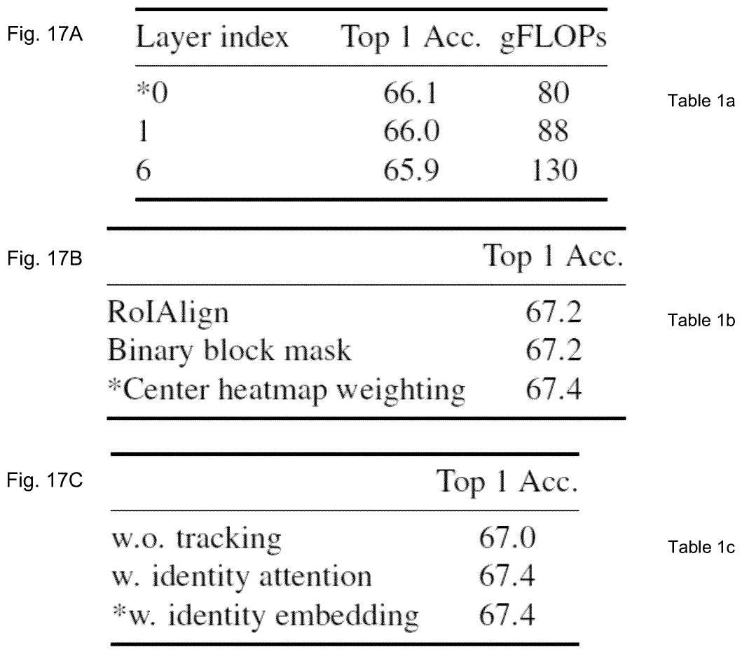

According to one aspect of the technology, OGS takes the full set of token as input and produces downsampled tokens. It can be applied to any blocks in the transformer. Intuitively, applying token downsampling in later layers reserves more information with the cost of more computation. Tables 1a-c in FIGS. 17A-C, illustrate results for when to drop tokens, object feature aggregation functions, and how to use tracking information, respectively. The * items indicate the default option.

Table 1a in FIG. 17A ablates doing token sampling in different layers. Here, the sampler was applied on different layers (without object attention), with 10% background tokens and 40% foreground tokens It can be observed dropping tokens at the very beginning before any transformer layers work as well as dropping in middle blocks, while being the most computationally efficient. Thus, in one scenario this early dropping may be used by default.

OAM aggregates patch features into object features. One way to do that is to crop and resize the box region in the feature grids. However, this is no longer feasible when the input features are unstructured patches after downsampling. In Table 1b of FIG. 17B, alternatives are compared to to RolAlign under the full token settings. A binary block mask that masks out input features outside of the bounding box region was first used, followed by linear layers and a global pooling. This matches RolAlign without cropping. The heatmap-weighted pooling (according to the equation for

$${w}_{o , t}^{l} )$$

further improves the block-mask, likely due to the center heatmap giving a better estimation of the object mask.

By default, the object-aware attention module does not use object tracking information as each object token is created per frame individually. Options were studied to add identity information in the framework when available (e.g., via a light-weighted tracker), comparing no tracking, using additional layers for tokens for the same object, or simply adding an identity embedding. Table 1c of FIG. 17C shows the results. Without any tracking information, our object-aware attention module still improves the baseline (66.1) by 0:9 points. Experiments were done with two ways to use tracking. The first was to apply an additional attention module on object tokens from the same track, and the second was to simply add the same embedding to objects within a track. It was observed that both further improve the performance by 0.4 points.

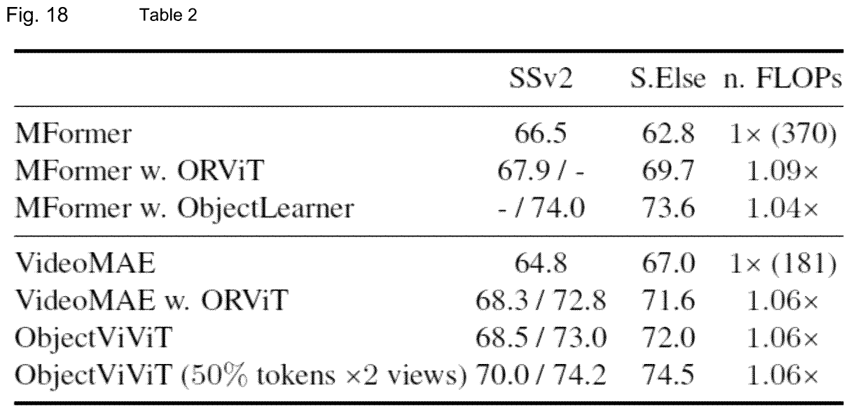

Comparisons were also made to existing methods on both object-based video modeling and token-efficient transformers. For object-based video representations, testing compared the full ObjectViVit model to ORViT and ObjectLearner on SomethingElse and SSv2 datasets. Ground truth boxes were used on SomethingElse and the same inferred boxes on SSv2. Both methods used MotionFormer as their baseline which requires full grid-shaped inputs, which are different from the baseline video vision transfomer. Thus, Table 2 in FIG. 18 reproduces ORViT on the baseline. The table presents normalized FLOPs (n. FLOPs) with respect to the corresponding baseline. Results on SomethingElse (S.Else) are with ground truth boxes and SSv2 using both inferred and ground truth boxes (results shown in format: inferred boxes/ground truth boxes). The results are reported with a single temporal view and 3 spatial crops except for the last row, which uses 3 spatial crops and 2 temporal views with 50% tokens. Table 2 show that the full ObjectViVit model outperforms ORViT. When using an optimal model with 50% tokens and multi-view testing, the model's gains are larger under the same normalized FLOPs.

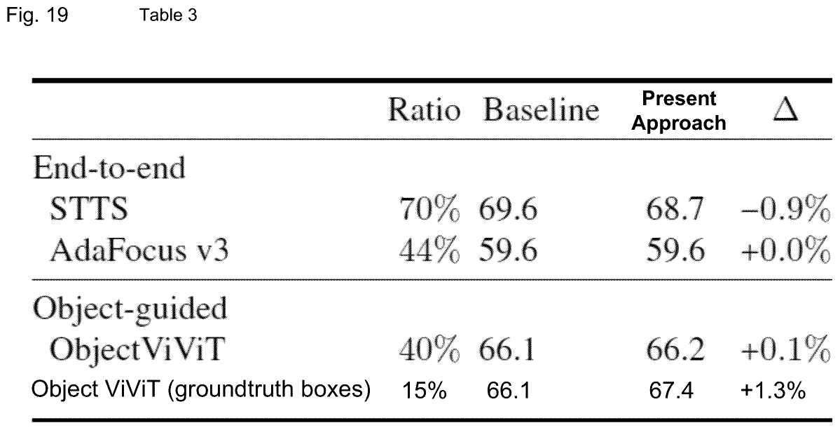

Finally, as shown in Table 3 of FIG. 19, results are presented in the context of existing token-efficient transformers for videos. For each method, numbers of tokens are presented with respect to its corresponding baseline, the baseline accuracy, the model accuracy for the present approach, and show the absolute performance change (4) with respect to the baseline. In the top block are existing end-to-end methods. STTS and AdaFocus both adaptively select video regions for action recognition on SomethingSomeghing-V2. In the bottom block are the object-guided models presented herein. The present model can be seen to achieve better token-efficiency compared to end-to-end methods with predicted boxes from detectors, and can be further improved with ground truth boxes. In particular, with bounding boxes from object detectors, the result of retaining baseline performance at 40% tokens and is in a favorable position compared to STTS and AdaFocus. The results with ground truth boxes further highlight the advantages of using objects as presented herein.

The above-described technology may be utilized in a compact, object-based video processing framework. The object-guided token sampling module can be used to drop background regions at an aggressive ratio. The object-aware attention module that utilizes object-token relation can be used to improve action classification accuracy with minor additional computation. The overall framework is able to improve both the token-efficiency and classification accuracy on action recognition benchmarks, as shown by the testing results. Finally, the system may use different types of object detectors. By way of example, this can include domain-specific detectors trained on human-action interaction datasets. Other types of detectors, such as discussed in “Exploring plain vision transformer backbones for object detection” by Li et al, 2022 (incorporated herein by reference in its entirety), may also be employed.

### Example Computing Architecture

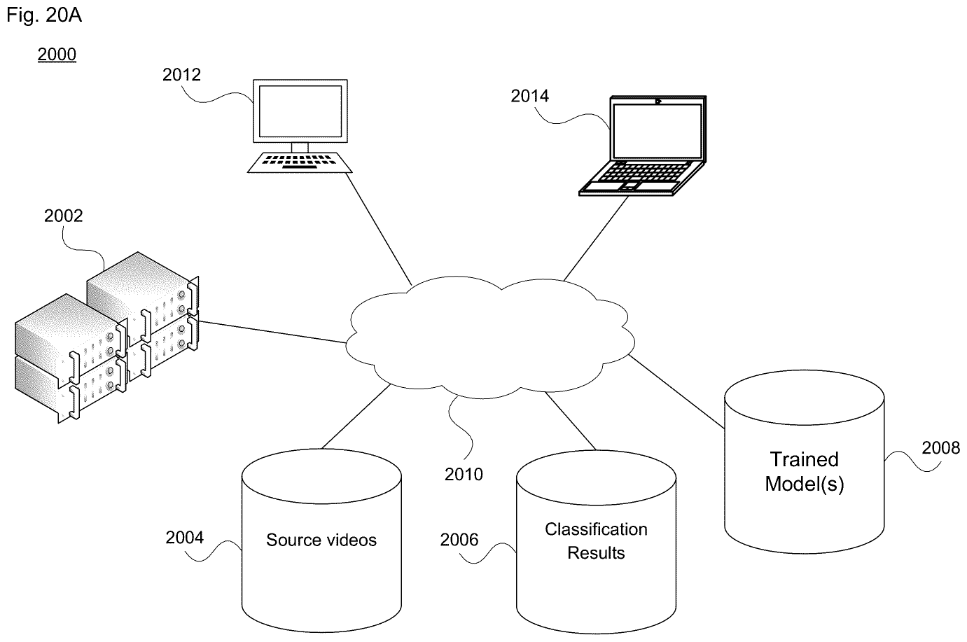

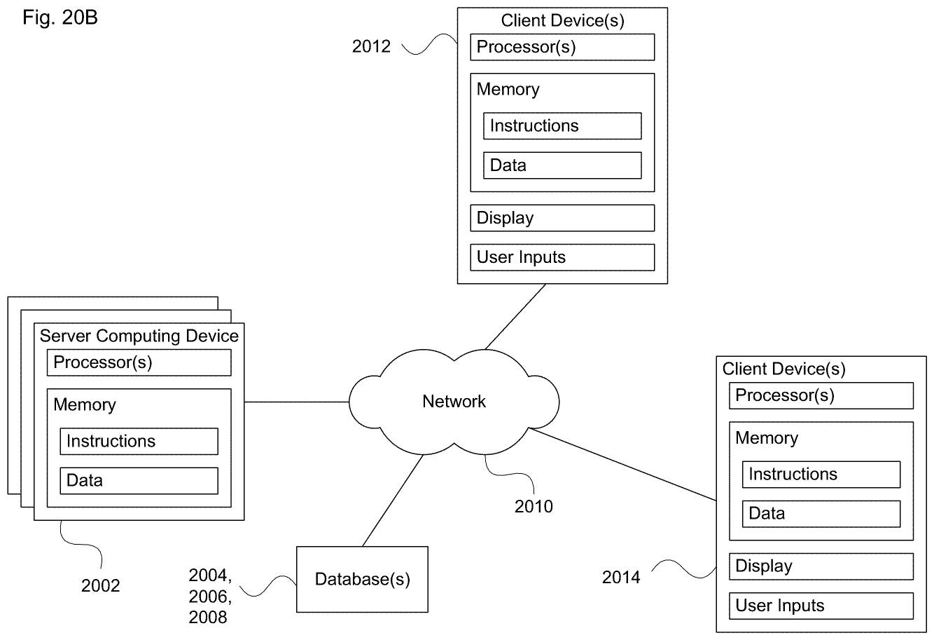

The ObjectViViT models discussed herein, including models using one or both of object-guided token sampling and an object-aware attention, may be trained on one or more tensor processing units (TPUs), CPUs or other computing in accordance with the features disclosed herein. One example computing architecture is shown in FIGS. 20A and 20B. In particular, FIGS. 20A and 20B are pictorial and functional diagrams, respectively, of an example system 200 that includes a plurality of computing devices and databases connected via a network. For instance, computing device(s) 2002 may be implemented as a cloud-based server system. Databases 2004, 2006 and 2008 may store, e.g., the original source videos (e.g., video segments or clips, or full videos), classification results or other output from video analysis based on the model(s), and/or trained models, respectively. The server system may access the databases via network 2010. Client devices may include one or more of a desktop computer 2012 and a laptop or tablet PC 2014, for instance to provide the original videos or other content, and/or to view the output (e.g., curated videos based on the classifications, which could be provided to the user via a web-based service, app or other program).

As shown in FIG. 20B, each of the computing devices 2002 and 2012-2014 may include one or more processors, memory, data and instructions. The memory stores information accessible by the one or more processors, including instructions and data (e.g., models) that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing, whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs, TPUs, graphical processing units (GPUs), etc. Alternatively, each processor may be a dedicated device such as an ASIC or other hardware-based processor. Although FIG. 20B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 2002. Accordingly, references to a processor or computing device will be understood to include references to a collection of processors or computing devices or memories that may or may not operate in parallel.

The input data, such as video segments or whole videos, may be operated on by a trained object-based video vision transformer model to generate one or more video classifications, object-aware attention module outputs updated features of patch tokens, or other data generated based on utilization of the model. The client devices may utilize such information in various apps or other programs to perform video understanding, quality assessment or other metric analysis, recommendations, classification, search, etc. This could include assigning rankings or video classifications to different videos based upon the results of the processing. By way of example, this can be employed to improve video recognition accuracy and/or reduce redundancy in the input videos.

The computing devices may include all of the components normally used in connection with a computing device such as the processor and memory described above as well as a user interface subsystem for receiving input from a user and presenting information to the user (e.g., text, imagery, videos and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users.

The user-related computing devices (e.g., 2012-2014) may communicate with a back-end computing system (e.g., server 2002) via one or more networks, such as network 2010. The network 2010, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 2002 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 2002 may include one or more server computing devices that are capable of communicating with any of the computing devices 2012-2014 via the network 2010.

Model information or other data derived from the approaches discussed herein may be shared by the server with one or more of the client computing devices. Alternatively or additionally, the client device(s) may maintain their own databases, models, etc.

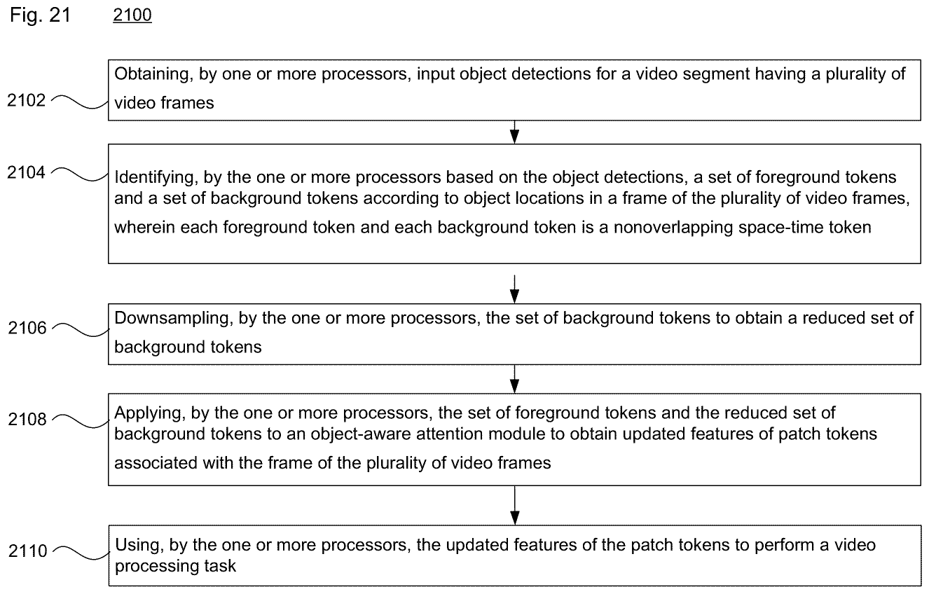

FIG. 21 illustrates an example flow diagram 2100 in accordance with aspects of the technology. At block 2102, the method includes obtaining, by one or more processors, input object detections for a video segment having a plurality of video frames. At block 2104, the method includes identifying, by the one or more processors based on the object detections, a set of foreground tokens and a set of background tokens according to object locations in a frame of the plurality of video frames. Each foreground token and each background token is a nonoverlapping space-time token. At block 2106, the method includes downsampling, by the one or more processors, the set of background tokens to obtain a reduced set of background tokens. Then at block 2108, the method includes applying, by the one or more processors, the set of foreground tokens and the reduced set of background tokens to an object-aware attention module to obtain updated features of patch tokens associated with the frame of the plurality of video frames. And at block 2110 the method includes using, by the one or more processors, the updated features of the patch tokens to perform a video processing task.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A computer-implemented method for use in classifying video data, the method comprising:
obtaining, by one or more processors, input object detections for a video segment having a plurality of video frames;
identifying, by the one or more processors based on the object detections, a set of foreground tokens and a set of background tokens according to object locations in a frame of the plurality of video frames, wherein each foreground token and each background token is a nonoverlapping space-time token;
downsampling, by the one or more processors, the set of background tokens to obtain a reduced set of background tokens;
applying, by the one or more processors, the set of foreground tokens and the reduced set of background tokens to an object-aware attention module to obtain updated features of patch tokens associated with the frame of the plurality of video frames; and
using, by the one or more processors, the updated features of the patch tokens to perform a video processing task.

2. The method of claim 1, wherein the identified foreground tokens are not downsampled.

3. The method of claim 1, further comprising defining an object score for each foreground token and each background token.

4. The method of claim 3, wherein the set of foreground tokens is identified for any tokens exceeding an object score threshold, and the set of background tokens is identified for any tokens not exceeding the object score threshold.

5. The method of claim 4, wherein the object score threshold is a configurable parameter.

6. The method of claim 3, wherein each object score is based on a set of heatmap values for a corresponding space-time token.

7. The method of claim 1, wherein the object-aware attention module is configured to obtain the updated features of the patch tokens based on the set of foreground tokens and the reduced set of background tokens, and a corresponding object score for each respective token.

8. The method of claim 1, wherein the updated features include a new object token by weighted pooling of the respective token and the corresponding object score.

9. The method of claim 1, further comprising concatenating object tokens and the patch tokens.

10. The method of claim 1, wherein the video processing task includes classifying the video segment.

11. The method of claim 10, wherein the classification is based on an action category.

12. An image processing system, comprising:
memory configured to store a set of video segments, each video segment having a plurality of video frames; and
one or more processors operatively coupled to the memory, the one or more processors being configured to:
obtain, from the memory, input object detections for given video segment;
identify, based on the object detections, a set of foreground tokens and a set of background tokens according to object locations in a frame of the plurality of video frames for the given video segment, wherein each foreground token and each background token is a nonoverlapping space-time token;
downsample the set of background tokens to obtain a reduced set of background tokens;
apply the set of foreground tokens and the reduced set of background tokens to an object-aware attention module to obtain updated features of patch tokens associated with the frame of the plurality of video frames; and
use the updated features of the patch tokens to perform a video processing task.

13. The image processing system of claim 12, wherein the identified foreground tokens are not downsampled.

14. The image processing system of claim 12, wherein the one or more processors are further configured to define an object score for each foreground token and each background token.

15. The image processing system of claim 14, wherein the set of foreground tokens is identified for any tokens exceeding an object score threshold, and the set of background tokens is identified for any tokens not exceeding the object score threshold.

16. The image processing system of claim 15, wherein the object score threshold is a configurable parameter.

17. The image processing system of claim 14, wherein each object score is based on a set of heatmap values for a corresponding space-time token.

18. The image processing system of claim 12, wherein the one or more processors, via the object-aware attention module, are configured to obtain the updated features of the patch tokens based on the set of foreground tokens and the reduced set of background tokens, and a corresponding object score for each respective token.

19. The image processing system of claim 12, wherein the updated features include a new object token by weighted pooling of the respective token and the corresponding object score.

20. The image processing system of claim 12, wherein the one or more processors are further configured to concatenate object tokens and the patch tokens.

21. The image processing system of claim 12, wherein the video processing task includes classifying the video segment.

22. The image processing system of claim 21, wherein the classification is based on an action category.
